(19) United States
(12) Patent Application Publication
(10) Pub. No.: US 2010/0051586 A1
(43) Pub. Date: Mar. 4, 2010

(54) Orbital welding system and methods of operations

(75) Inventors: Michael Guerrina, Austin, TX (US); Carlos Jobe, Austin, TX (US)

Correspondence Address: HULSEY IP INTELLECTUAL PROPERTY LAWYERS, P.C., 919 Congress Avenue, Suite 919, AUSTIN, TX, 78701, US

(73) Assignee: Apparent Technologies, Inc., Austin, TX (US)

(21) Appl. No.: 12/387,721

(22) Filed: May 6, 2009

Related U.S. Application Data
(60) Provisional application No. 61/050,858, filed on May 6, 2008.

(51) Int. Cl. B23K 11/00

(52) U.S. Cl. 219/59.1

(57) ABSTRACT

An orbital welding system and methods of operation controllably and safely weld a first metal tubing to a second metal tubing. A weld head includes interlocking clamping jaws for clamping the tubing. An alignment mechanism aligns the second tubing with the first tubing. The interlocking clamping jaws clamp the second tubing following the aligning of the second tubing with the first tubing. An alignment measurement mechanism measures relative alignment between the first tubing and the second tubing. A weld environment mechanism establishes a gaseous environment for orbitally welding the first tubing to the second tubing. The weld environment mechanism includes a weld environment sealing mechanism for sealing the gaseous environment and an electrode for gas arc welding. The weld environment mechanism orbits the first tubing and second tubing during the orbitally welding. Interface circuitry interfaces a power supply with the weld head and controls parameters associated with said weld head.

### CROSS REFERENCE TO RELATED APPLICATIONS

This U.S. patent application claims the benefit of priority of U.S. Provisional Patent Application No. 61/050,858 filed May 6, 2008 entitled, “Orbital Weld Head System,” by inventor Michael Guerrina.

### FIELD

The present subject matter relates generally to orbital welding system and methods of operations, and more particularly, to a system and method for an orbital weld head system with automated clamping and alignment measurement.

### DESCRIPTION OF THE RELATED ART

An orbital welding system consists of a solid-state power supply (operating from 110 VAC) and a rotor and electrode housed in the orbital weld head. The power supply and microprocessor technology system supplies and controls the system's output characteristics, i.e., welding parameters, like the arc welding current, the power to drive the motor in the weld head, and the switching on and off of the shield gas, are programmed.

In automatic orbital welding systems, a clamping mechanism clamps tubes or pipes in place. This orbital welding process uses the Gas Tungsten Arc Welding (GTAW; also referred to as TIG welding) process as the source of the electric arc that melts the base material and forms the weld. The heat found at the tungsten tip can be between approx. 2400 to 2800 degrees F. The orbital welding process establishes an electric arc between a non-consumable tungsten electrode (typically two percent thoriated Tungsten or two percent ceriated Tungsten) and the part to be welded, called the weld puddle. To initiate the electric arc, an RF or high-voltage signal ionizes the shielding gas (usually argon) to start a path for the weld current.

The orbital weld head rotates the tungsten electrode and the electric arc around the weld point to join the adjoining surfaces. Orbital weld heads are usually of the enclosed type with an inert atmosphere chamber that surrounds the weld joint. An inert shielding gas, most commonly argon, is fed through the weld head (or torch). Shield gas is required during welding to protect the electrode, molten weld puddle and solidifying weld metal from atmospheric contamination.

Orbital welding process applications range from non-critical to critical, high-purity uses, including semiconductor and pharmaceutical applications. Orbital welding is in great demand, especially for welding of tubing of small circumference, because of the ease in which the welding process can be controlled. Orbital welding however does not solve the problem of misalignment.

Orbital welding equipment can drastically outperform manual welders qualitatively and quantitatively and consistently yield a much higher quality of weld without the normal variability, inconsistencies, errors or defects of manual welding. Also, orbital welding may be used where a tube or pipe to be welded cannot be rotated or readily rotated, or where space restrictions limit the physical size of the orbital welding equipment.

In orbital welding machine there is need for improvement in how a computer-controlled welding machine works in conjunction with a weld head to holds the two pieces of weldable material together during the welding process.

There is a further need to assure that the alignment of the pieces of weldable material occurs rapidly, reliably, and accurately.

A further need exists to overcome the problem during orbital welding of the operator either having to view the alignment between the two pieces of weldable material to each other and position the junction of the two pieces in line with the electrode or to use a “feeler” gauge such as a small screwdriver.

Yet a further need exists for an improved orbital welding process that avoids the need to position the tube junction for welding in line with the electrode to ensure a proper weld.

Still further improvement is needed in the orbital weld processes and equipment that prevents weldable material pieces from separating during the welding process due to twisting or other stresses arising during welding.

A need exists to prevent or eliminate twisting of the weld area as the orbital weld electrode rotates around the abutment junction being welded.

In orbital welding, skilled welders commonly align the two pieces of weldable material and make several temporary spot welds or “tack” welds around the circumference of the abatement junction prior to final welding. But, when using tack welding, proper alignment is critical, and therefore, tack welding, by itself, does not address the problem of creating acceptable alignment in a time efficient manner.

A further need exists for an orbital welding system that has the ability to interface a wide variety of welding power supplies easily and quickly.

A need exists for an orbital welding system that adds to the orbital welding process a level of automation and programmed logic to ensure more efficient and safe orbital welding. This need exists not only in a workbench welding setting, but also in a field setting.

A need yet exists for an orbital welding system that has the ability to quickly and easily weld different diameters of weldable materials.

Yet a need exists for an orbital welding system that can accommodate different orbital welding situations and in such situations minimize twisting and other weld stresses by independently applying clamping forces to the two pieces of material being welded.

A need exists for an improved orbital welding system that incorporates an advanced cooling design for greater system reliability and safety, as well as a greater duty cycle in manufacturing and maintenance settings.

Yet a need exists for an orbital welding system that provides a reliable indication of an alignment value between two pieces of metal tubing being welded.

Finally, a need exists for an orbital welding system that forms a tight weld gas environment to prevent reactions with oxygen and reactive gas during and after welding, as well as to prevent the need and avoid the costs of brushing the resulting weld area with such reactions occur.

### SUMMARY

The present disclosure shows an orbital welding system and methods of operations that meets and/or satisfies the aforestated concerns.

According to one aspect of the present disclosure, there is here provided an orbital welding system and methods of operation for controllably and safely welding a first weldable tubular material to a second weldable tubular material. The weldable materials may include a wide variety of metals formed as metal tubing. The presently disclosed subject matter includes a weld head for orbitally welding the first weldable tubular material to the second weldable tubular material. The weld head further includes interlocking clamping jaws for sequentially clamping the first weldable tubular material to the second weldable tubular material. An alignment mechanism aligns the second weldable tubular material with the first weldable tubular material following said interlocking clamping jaws first clamping said first weldable tubular material. The interlocking clamping jaws clamp the second weldable tubular material following the aligning of the second weldable tubular material with the first weldable tubular material. An alignment measurement mechanism measures relative alignment between the first weldable tubular material and the second weldable tubular material. A weld environment mechanism establishes a gaseous environment for orbitally welding the first weldable tubular material to the second weldable tubular material. The weld environment mechanism includes a weld environment sealing mechanism for sealing the gaseous environment and an electrode for gas arc welding. The weld environment mechanism orbits the first weldable tubular material and second weldable tubular material in orbitally welding the first weldable tubular material with the second weldable tubular material. Weld head interface circuitry interfaces a welding power supply with the weld head and programmably controls operational and safety parameters associated with said weld head.

These and other advantages and aspects of the disclosed subject matter, as well as additional novel features, will be apparent from the description provided herein. The intent of this summary includes not to be a comprehensive description of the claimed subject matter, but rather to provide a short overview of some of the subject matter's functionality. Other systems, methods, features, and advantages here provided will become apparent to one with skill in the art upon examination of the following FIGUREs and detailed description. It includes intended that all such additional systems, methods, features and advantages be included within this description, be within the scope of the accompanying claims.

### BRIEF DESCRIPTIONS OF THE DRAWINGS

The present subject matter will now be described in detail with reference to the drawings, which are provided as illustrative examples of the subject matter so as to enable those skilled in the art to practice the subject matter. Notably, the figures and examples are not meant to limit the scope of the present subject matter to a single embodiment, but other embodiments are possible by way of interchange of some or all of the described or illustrated elements and, further, wherein:

FIGS. 1 and 2 show different aspects of the presently disclosed orbital welding system with automated clamping and alignment measurement;

FIG. 3 illustrates an embodiment of the principal components of an embodiment of the presently disclosed orbital welding system;

FIG. 4 shows an example of a welding system power supply system that may support the presently disclosed orbital welding system to various power supplies;

FIG. 5 presents various weld pressure gas components for supporting an orbital welding system that may cooperate with the novel aspects of the presently disclosed subject matter;

FIGS. 6 and 7 illustrate embodiments of the presently disclosed system as may be applied to table-based orbital applications for different orbital welding applications;

FIGS. 8 and 9 show different embodiments of a weld head for use with the presently disclosed system;

FIG. 10 depicts an isometric view of the weld head embodiment of FIG. 8;

FIGS. 11 through 18 provide detailed configuration diagrams for the weld head embodiment of FIG. 8;

FIGS. 19 through 24 depict varying views of an interlocking race for orbital welding system

FIGS. 25a, 25b and 26 illustrates an embodiment of a spring collet for use in the disclosed embodiment of interlocking clamping jaws;

FIGS. 27 and 28 illustrate an embodiment of a torsion assembly within interlocking clamping jaws of the disclosed embodiment;

FIG. 29 through 30 illustrate aspects of the disclosed orbital welding system for determining and misalignment between two metal tubing segments;

FIGS. 32 through 35 present various cut-away and exploded views of an embodiment of a weld head for the presently disclosed orbital welding system;

FIG. 36 presents an embodiment of the orbital weld head gear drive and center pin;

FIGS. 37a and 37b show, respectively, outer and inner views of weld head interface box for use between a welding system power supply and the presently disclosed orbital welding system;

FIGS. 38 and 39 show isometric views of a quick disconnect cable connection for an embodiment of the presently disclosed orbital welding system;

FIGS. 40a and 40b present views of an flexible circuit as appearing in an embodiment in the presently disclosed weld head;

FIGS. 41 through 43 illustrate an embodiment of control process operating within the presently disclosed orbital welding system;

FIGS. 44 through 50 depict use of an embodiment of the presently disclosed orbital welding system for welding smaller diameter metal tubing;

FIGS. 51 and 52 further depict use of another embodiment of the presently disclosed orbital welding system for welding a larger diameter metal tubing; and

FIGS. 53 and 54 yet further depict use of the presently disclosed orbital welding system in a field situation.

### DETAILED DESCRIPTION OF THE ILLUSTRATIVE EMBODIMENTS

In the present specification, an embodiment showing a singular component should not be considered limiting. Rather, the subject matter encompasses other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present subject matter encompasses present and future known equivalents to the known components referred to herein by way of illustration.

More information regarding the field of this invention appears in the following patents, all of which have common assignment and inventorship: U.S. Pat. No. 5,679,271, entitled “Apparatus and method for precisely aligning and tack welding two pieces of weldable material”; U.S. Pat. No. 6,121,567, entitled “Apparatus and method for precisely aligning and welding two pieces of weldable material”; U.S. Pat. No. 6,459,062, entitled “Apparatus and method for precisely aligning and welding two pieces of weldable material”; and U.S. Pat. No. 7,026,568, entitled “Ceramic weld insulator and metal weld gear combination for an improved micro weld head component of an orbital tube welding apparatus” all of which are incorporated by reference in their entirety for all purposes into this detailed description.

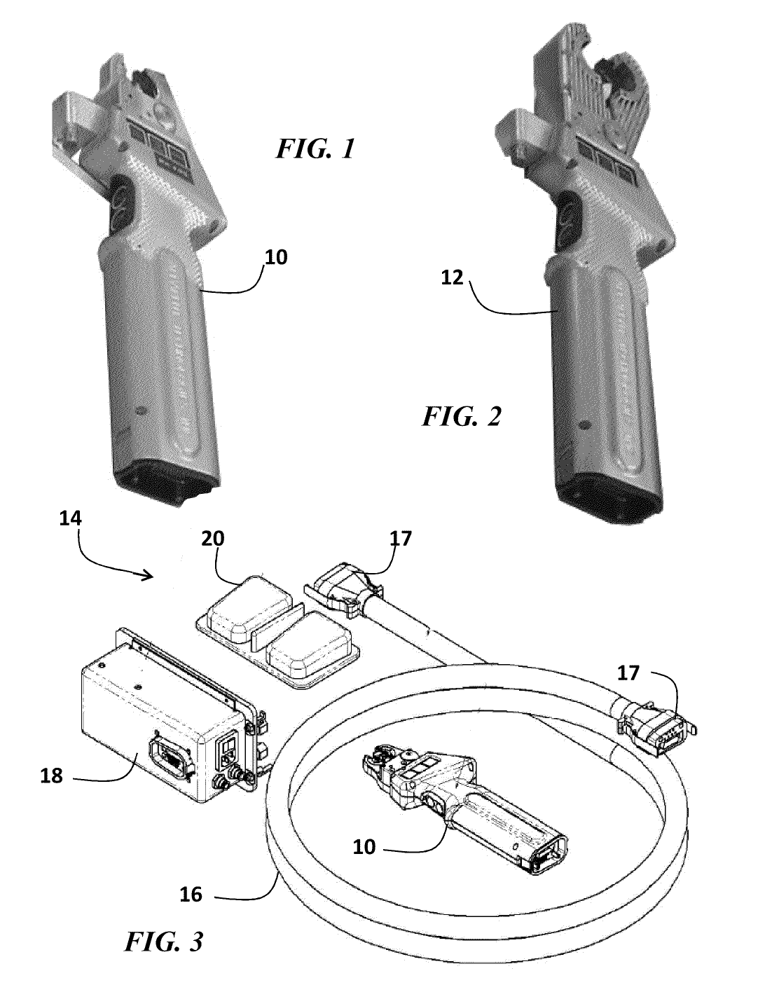

FIGS. 1 and 2, respectively, show different aspects of novel weld head 10 for smaller diameter metal tubing and weld head 12 for larger diameter for use with the presently disclosed orbital welding system. FIG. 3 illustrates an embodiment of the principal components of the presently disclosed orbital welding system 14. The presently disclosed orbital welding system 14 includes weld head 10 for connecting with weld head interface cable 16. At each end of interface cable 16 appear quick disconnect cable connections 17. Weld head interface cable 16 may connect at one end via quick disconnect cable connection 17 to weld head interface box 18 for providing control and operating connections to weld head 10. At the other end, interface cable 16 may connect via a quick disconnect cable connection 17 to weld head 10. System controls for orbital welding system 14 include weld head control pedals 20.

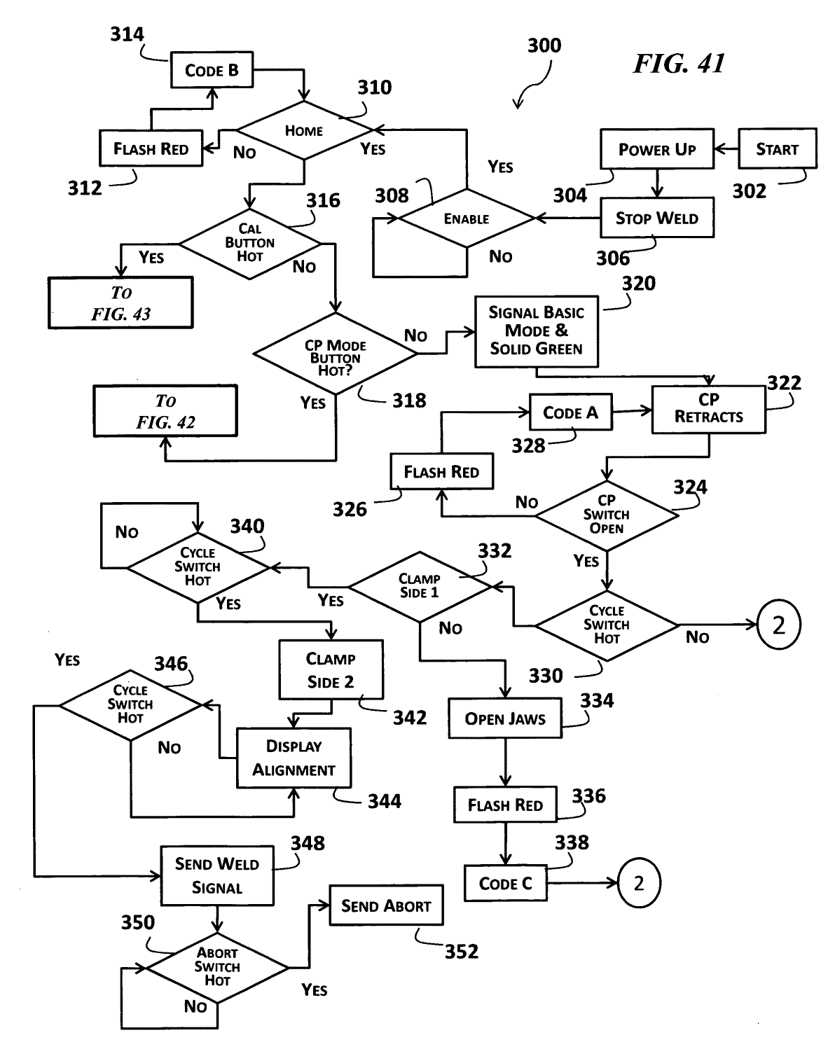

Orbital weld head 10 may adapt to various welding power supplies using weld head interface box 18, as well as provide automated clamping and alignment. Controlling the automation is handled by a program logic controller within weld head interface box 18. The program logic (described below in FIGS. 41 through 43) controls the sequence of clamping, alarms and the weld start command to effectively and reliably automate a significant portion of the orbital welding process. Weld head 10 may be operated using weld hed foot pedal 20 or hand operated by depressing buttons located on the weld head 10 handle. In the high volume-manufacturing environment weld head 10 may be table mounted. In a table mounted configuration, weld head foot pedal 20 allows hands free weld head 10 operations. The result is even more operator ease and improved weld quality with greater efficiency and reduced setup time.

Weld head 10 displays alignment of the metal tubing to be welded without the need to look inside the weld head. The result is reduced setup time and a more accurate orbital weld. Alignment is displayed in an operator display located on weld head 10. Based on the value of the displayed alignment, an operator may decide whether the alignment is within specified alignment range. A retractable centering pin allows quick alignment of the electrode with the center on the weld joint.

Weld head interface box 18 allows for the conversion of various power supplies that may be operating in the industry to adapt to orbital weld head system 14. This adaptation reduces the need to replace the current power supplies, thereby reducing the overall costs of using orbital weld head system 14.

Weld head cable 16 provides identical quick disconnects 17 on either end. As such connection to both weld head 10 and weld head interface box 18 occurs almost instantaneously using nimble universal connections. Weld head cable 16 may disconnect from weld head 10 to allow a single to serve a variety of different weld heads for welding a wide variety of tubing diameters. Quick disconnect 17 permits weld head 10 connection in seconds, as well as avoids the need for tools or power supply 22 access. That is, power supply 22 may be at least 20 feet or more from the orbital welding location, because the interchange functions that quick disconnects 17 provide.

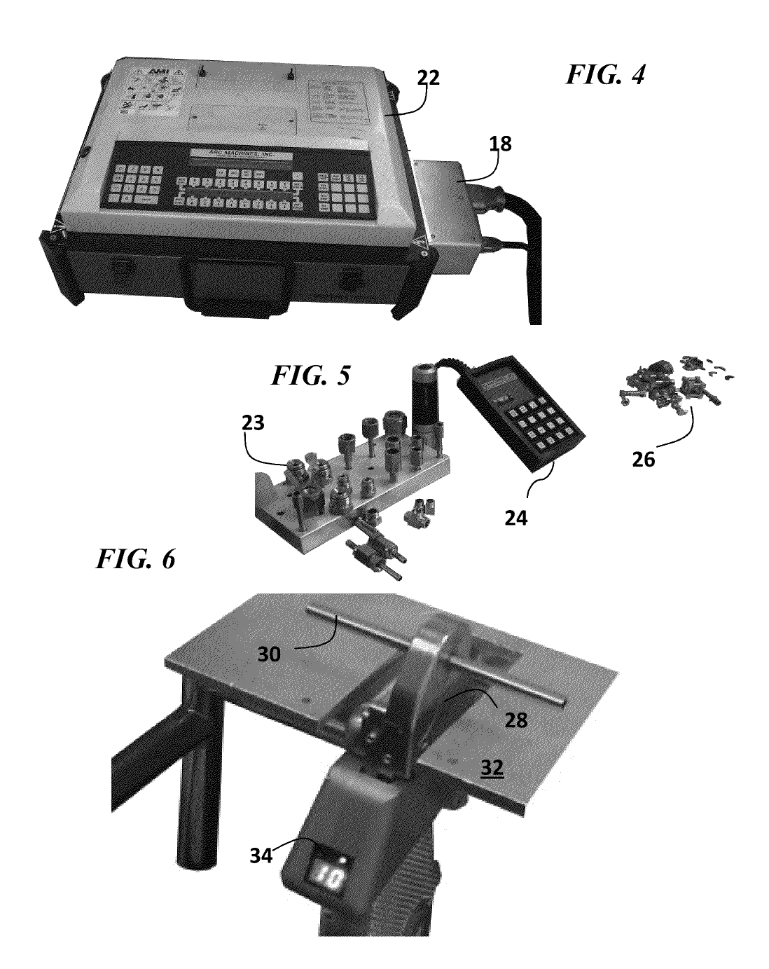

FIG. 4 shows an example of a welding system power supply system 22 that may employ the presently disclosed orbital welding system 14 to various power supplies. Connecting with welding system power supply 22 is weld head interface box 18. FIGS. 37a and 37b, below, describe in detail the physical aspects of weld head interface box 18. Also, FIGS. 41 through 43, below, describe in detail the control and logic functions enabled by the cooperation of weld head 10 and weld head interface box 18.

FIG. 5 presents various weld pressure gas components of an orbital welding system that may cooperate with the novel aspects of the presently disclosed subject matter. For example, connectors 23 may seal ends of tubing which orbital welding system 14 holds with weld head 10. Controls for weld pressure gas include keypad 24 and associated pressure gauges 26.

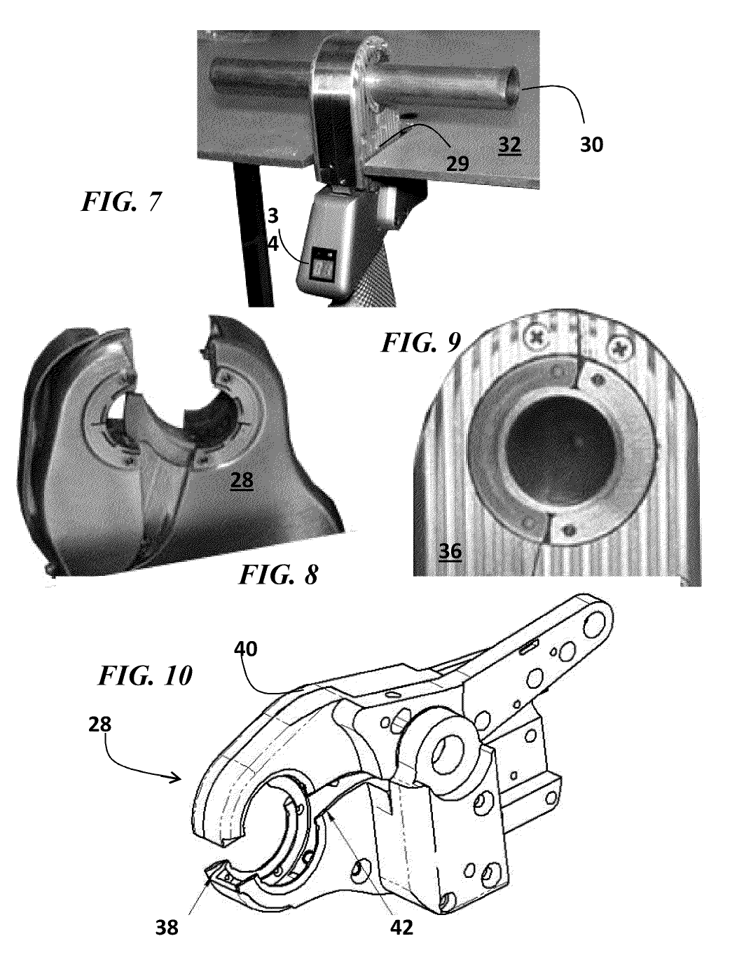

FIGS. 6 and 7 illustrate embodiments of the presently disclosed system as may be applied to table-based orbital applications for different orbital welding applications. That is, FIG. 6 depicts an operational configuration of weld head 10 wherein interlocking clamping jaws 28 hold and may perform an orbital weld of metal tubing 30. This configuration of FIG. 6 makes use of workbench 32 for holding in place and supporting weld head 10. With weld head 10 secure, an operator may both use weld head control pedals 20 for controlling weld head 10 and operator display 34 for viewing the various operational outputs that orbital welding system 14 provides. Similarly, FIG. 7 depicts an alternative operational configuration that includes larger weld head 12 also using workbench 32.

Typically, the metal tubing 30 is available in 20-foot lengths. So, a tubing weld will be needed at least every 20 feet. Moreover, wherever there may be joints, pressure gages, fittings, control valves, or other fittings a weld will be necessary. As will been seen, the presently disclosed orbital welding system 14 has the ability to address easily and effectively essentially all possible welding applications in a more controlled and cost-effective manner than has heretofore been possible.

FIGS. 8 and 9 show different embodiments of a weld head for use with the presently disclosed system. FIG. 8 provides a view of interlocking clamping jaws 28 for handling the smaller metal tubing, while FIG. 9 shows the stronger and larger interlocking clamping jaws 36 for handling the larger diameter tubing.

FIG. 10 depicts an isometric view of the weld head embodiment of FIG. 8 and begins the more detailed description of the disclosed embodiment. In particular, FIG. 10 illustrates an embodiment of interlocking clamping jaws 28 for weld head 10, which includes extended flange 38, allows for interlock with the top jaw 40. Bottom jaw 42 interlocks with top jaw 40 along extended flange 38.

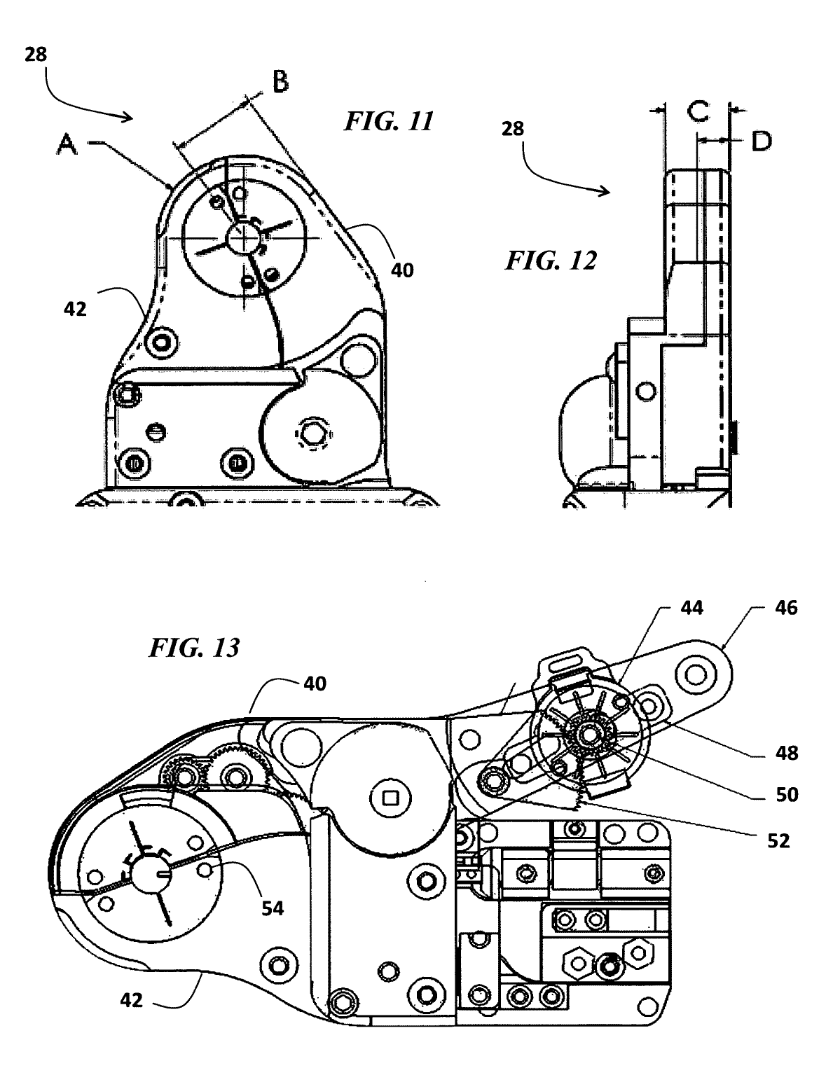

FIGS. 11 through 18 provide detailed configuration diagrams for the weld head embodiment of FIG. 8. FIG. 11 shows one embodiment of the presently disclosed interlocking clamping jaws 28 for orbital welding system 14, as shown in FIG. 8. Currently, applicant markets a weld head having such a design under the designation “R50.” The R50 orbital welding system may provide an orbital weld to tubing ranging in outside diameter (O.D.) from ⅛ to ½″ O.D. In particular the R50 design of weld head may have dimensions along cross-sectional line A of 0.63″, line B of 0.63″ when interlocking clamping jaws 28 are in a closed position (i.e., when top jaw 40 and bottom jaw 42 join), and line B of 1.27 when in a closed position (i.e., top jaw 40 and bottom jaw 42 separate a maximum distance). FIG. 12 shows the width of the disclosed embodiment along line C, which may be 0.48″ and a side distance D to the internal welding electrode of 0.25″.

In contrast, the larger embodiment of interlocking clamping jaws 36 (see FIG. 9), which applicant currently markets with the designation “R100,” may provide an orbital weld for tubing ranging from ¼ to 1″ O.D. In an embodiment of interlocking clamping jaws 36 larger dimensions may exist. For example, interlocking clamping jaws 36, which may have dimensions along cross-sectional line A of 1.10″, line B of 1.10″ when interlocking clamping jaws 36 are closed, and line B of 2.00″ when interlocking clamping jaws 36 are open. Similarly, the width of the disclosed embodiment of interlocking clamping jaws 36 along line C may be 1.40″, with the side distance D to the internal welding electrode of being 0.70″.

FIG. 13 illustrates further components of interlocking clamping jaws 28 that support the claimed benefits of automated clamping, automated electrode centering, and alignment verification, auto-cooling using a compact robust design, snap-in collets, all with a high duty cycle. The view of FIG. 13, further shows spring collets 54, which are discussed more fully below in association with FIGS. 25 through 26.

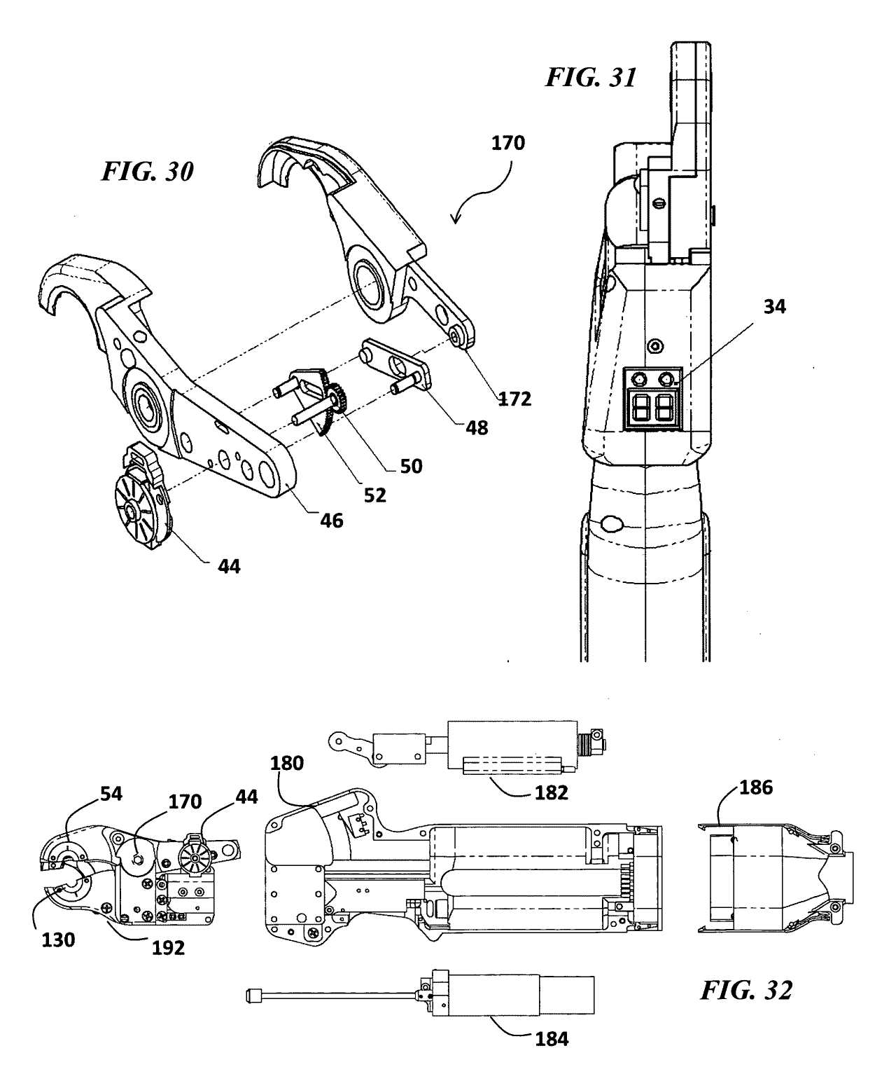

In FIG. 13, associated with top 40 may be encoder 44, which associates with left top jaw arm 46. Link 48 connects with pinion 50 and rack 52. Top jaw 40 provides for the alignment between two weldable pieces of tubular material. When welding two pieces of tubular material the alignment is critical to insure a proper weld joint. The alignment verification of interlocking clamping jaws 28 avoids the need to rely on an operator looking inside the weld head 10 to verify the weld meets the alignment specification required for a proper orbital weld. Operation of the disclosed alignment verification functions of the disclosed interlocking clamping jaws is disclosed in more detail below in association with FIG. 30.

Interlocking clamping jaws 28 provide the ability to clamp the tubes accurately enough to eliminate the need for visual verification of the weld joint. In addition, interlocking clamping jaws 28 provide sufficient clamping rigidity to overcome any external forces on the tubes such as gravity. When welding in field applications, the location of the weld may vary greatly. With interlocking clamping jaws 28, there are not operational restriction when the need arises to perform welds in limited access locations. By not needing to visually inspect alignment, interlocking clamping jaws prevent the need to use, as is the case in over-head welds and welds inside control cabinets, a mirror to look inside the weld head to check the alignment of the tubes prior to welding. Interlocking clamping jaws 28 avoid the need for an operator to view inside the weld head to verify alignment.

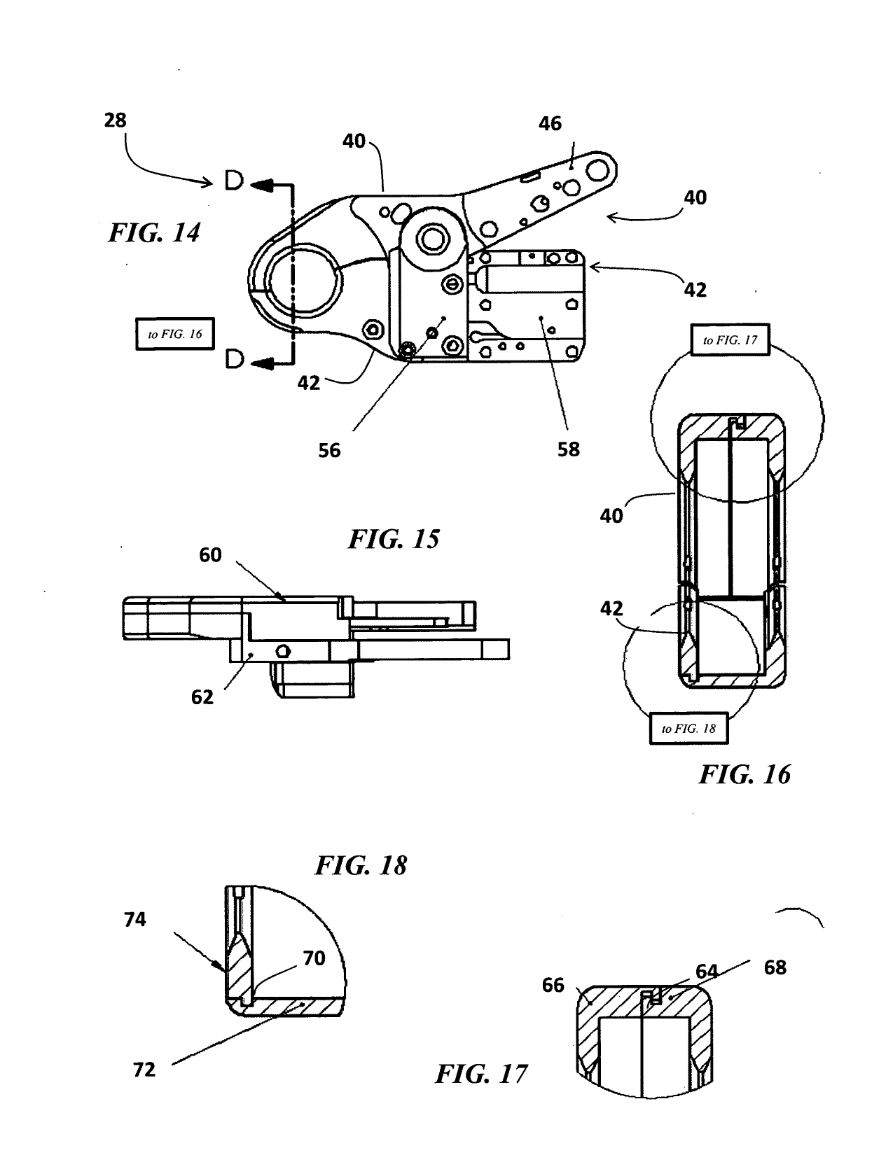

FIGS. 14 through 18 show additional design considerations embodied within interlocking clamping jaws 28. In particular, FIG. 14 shows a side view of interlocking clamping jaws 28, including bottom jaw upper portion 56, bottom jaw lower portion 58, and left top jaw arm 46. Bottom jaw 42 interlocks with top jaw 40 to form the required accurate clamping for a wide variety of orbital welding uses. Interlocking clamping jaws 28 provide top jaw 40 to prevent twisting that may occur during the clamping of metal tubing 31. This provides untwisted and minimal movement of the tubing and permits a higher degree of accuracy and repeatability required for the integration of an alignment verification system.

Bottom jaw lower portion 58 provides a main structural element for bottom jaw 42, as well as secures a gear assembly and interlocks to bottom jaw upper portion 56. Together, bottom jaw upper portion 56 and bottom jaw lower portion 58 become a fixed clamping surface for receiving and securing metal tubing 31. The interlock arrangement shown in FIG. 17 allows for greater radial clearance of the parts during welding. The interlocking allows for rigid secure fixed clamping surface. Without the interlocking arrangement, orbital welding would require addition screws for holding two pieces of metal tubing 30 together. Because the presently disclosed weld head avoids this requirement, a smaller dimension and more useable weld head results.

Referring to FIG. 15, right top jaw portion 60 and left top jaw portion 62 are shown to interlock to prevent twisting that may occur when clamping down on two pieces of metal tubing 30 as during welding. The interlock of top jaw portions 60 and 62 is similar to a tongue and groove style that follows the perimeter of interlocking clamping jaws 28 and maximizes the surface area that interlocked. The interlock also provides a partially unitized clamping arrangement improving rigidity and independent movement throughout extreme the operating temperatures of orbital welding. Interlocking top jaw portions 60 and 62, thus, substantially eliminates twisting that may occur while clamping metal tubing 30 pieces for both alignment and welding.

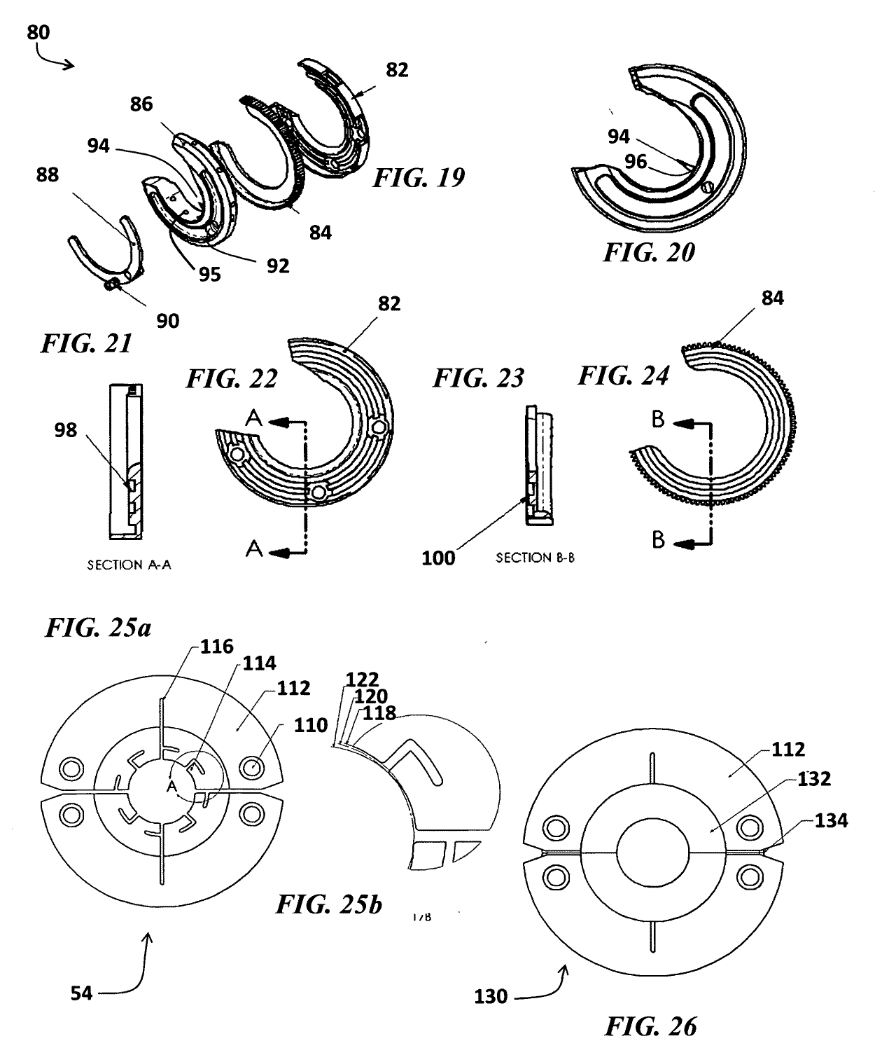

FIG. 16 shows a cross-sectional view along line D-D of FIG. 14 and depicts closed interlocking clamping jaws 28 with top jaw 40 adjoining bottom jaw 42. A closer view of the top jaw 40 cross-section appears in FIG. 17. The FIG. 17 closer view of the top jaw 40 cross-section shows a tongue-in-groove joint 64 between sidepieces 66 and 68. Likewise, the FIG. 18 closer view of the bottom jaw 42 cross-section shows a tongue-in-groove joint 70 between sidepieces 72 and 74.

FIGS. 19 through 24 depict varying views an interlocking race 80 for orbital welding systems with an embodiment providing an integrated structure for the orbital weld gear, and electrical insulator, and an electrical strip for conducting welding electric charge. Operation of interlocking race 80 within weld head 10 is further discussed below in association with FIG. 35. Referring to FIGS. 19 and 20, interlocking race 80 associates metal fixed race 82 to receive weld gear 84. Weld gear 84 couples with ceramic insulator 86. Ceramic insulator 86 adjoins and couples with electrical strip 88 through which tungsten cam 90 passes. Also, ceramic insulator 86 receives tungsten cam 90 in socket 92 and electrode 94 within socket 96. Sockets 92 and 94 are formed so that tungsten cam 90 may secure electrode 94 firmly in place.

Referring to socket 92, there are a set of argon gas apertures 95 for flowing argon gas from an external source (not shown) and establishing the orbital welding environment. The orbital weld is process is initiated to supply an electric charge to tungsten cam 90 which will then cause electrodes 94 to arc, thereby beginning the weld. An electric motor or similar device rotates interlocking race 80. The rotation of the interlocking race 80 allows electrode 94 to revolve around the junction between two metal tubing 30 segments that are being welded to create a complete weld of the abutment junction.

Referring to FIGS. 21 and 22, metal fixed race 82 includes interlock race groves 98. Also, referring to FIGS. 23 and 24, weld gear 84 includes interlock grooves 100. Thus, interlock grooves 98 and 100 provide multi-track designs for interlocking metal fixed race 82 and weld gear 98, respectively, to the rotating weld rotor and the ability to drain the intense amount of heat thru the metal race into the weld head assembly.

U.S. Pat. No. 6,121,567, entitled “Apparatus and Method for Precisely Aligning and Welding Two Pieces of Weldable Material,” and having common inventorship hereof (herein the '567 Patent), describes and claims an apparatus and associated method for precisely aligning two pieces of weldable material and welding the two pieces. The disclosed subject matter of the '567 Patent includes an apparatus containing means for independently securing the two pieces of weldable material and for centering the junction of the two pieces in line with the welding electrodes.

The '567 Patent further discloses an external welder to supply an electric charge so as to cause electrodes 96 of FIG. 21 hereof to arc to weld two metal tubing segments. An electric motor or similar device rotates a u-joint, which, in turn, rotates the primary drive gear. A primary drive gear then rotates a secondary drive gear, thereby rotating insulating gears a total of approximately 130 degrees. The rotation of insulating gears allows an electrode, such as electrode 96 of FIG. 21, to revolve around the abutment junction, thereby creating a complete weld of the abutment junction. After the weld process is complete, clamping jaws, such as interlocking clamping jaws 28, open to allow removal of the welded metal tubing. The subject matter of the '567 Patent is fully incorporated here by reference as may be beneficial for understanding the presently disclosed subject matter.

The multi-track configurations of interlock grooves 98 and 100 provide a sufficient amount of support for interlocking race 80 to hold ceramic insulator 86, while also providing a smooth rotation of the electrode. Additionally, the concentricity and duty cycle of the welding rotor directly relates to the fit between the fixed supporting race and the rotating welding rotor. The thin cross section is required to allow short tube stubs to be welded. However, this compromises the supporting surface area.

The improved interlocking race 80, with interlock grooves 98 and 100, secures the fixed race to the rotating weld rotor. Multiple interlocks of interlock grooves 98 and 100 provide greater surface area and allow the necessary tolerances between the components. In addition, the greater surface area of the multi-track interlocking race 80 more completely and effectively drains the intense amounts of heat through interlocking race 80 and into weld head 10 for auto-cooling between sequential welds.

FIGS. 25a, 25b and 26 illustrate an embodiment of a spring collet 54 for use in the disclosed embodiment of interlocking clamping jaws 28. Spring collet 54 provides a specific amount of travel to match the tube and fitting manufacturer's variance. Spring collet 54 includes collet 110 within collet fixture plug 112. Interior to collet fixture plug 112 appear a set of contact pads 114 and associated spring relief split 116.

In the field of orbital welding, there are several types of clamping methods to hold metal tubing 31. The alignment accuracy of the metal tubing to be welded is limited to the tube variance from nominal size and spring collet 54 provides ability to compensate for variances in metal tubing 30 diameter. A typical tube variance may range between ±0.005″. The disclosed embodiment of spring collet 54 allows for variance in metal tubing 30 size. However, the spring clamping surface is not limited to the tube variance. This allows the tubes either to move during the weld or to be clamped misaligned. Spring collet 54 allows for a specific tube size variance that complies with the tube and fitting manufacturers. Because the spring travel is limited to this variance, spring collet 54 provides improved alignment accuracy and clamping rigidity.

Additionally, spring collet 54 provides a quick-change design allowing an operator to switch tube sizes efficiently. Spring collet 54 may be removed and installed by squeezing the two collet fixture plugs 112 inward to compress the spring relief split 116. This will release collet 110 to allow a quick change to different sizes.

Referring to FIG. 25b, collet contact pad 114 is formed of a series of arcs to allow uniform contact/pressure on multiple points on the parts. Radius 118 represents the smallest diameter that may be effectively clamped, while radius 120 represents the largest. Radius 122 illustrates the arc designed to compress to sizes between radius 118 and radius 120.

FIG. 26 illustrates an embodiment of a collet seal 130 that significantly reduces the leakage of atmosphere into the welding environment. Collet seal 130 includes collet fixture plug 112, as described above. Spring pad/tubing seal 132 fits within collet fixture plug 112. Weld head seam seal 134 may connects symmetric halves of collet fixture plug 112.

The nature of the welding process involves sufficient heat to fuse the two pieces of weldable material together. The use of inert gases to protect the weld joint from oxidation during the weld process is necessary. Orbital welding involves the use inert gases both inside metal tubing 30, as well as outside of the welding area. The inert gas outside the welding area provides a head purge of reactive gases. Head purge inert gasses may include argon gas to aid in providing a clean weld. Inert argon gas in the welding area, assures that other gases such as oxygen, do not react with the welding metal. Weld head 10 not only shields the welding area, but also seals the welding area from gases leaking in.

A common practice in orbital welding involves the use of a wire brush for cleaning the welded metal tubing 30 upon completion of the welding in order to remove oxidation residue and reactive elements from the joint. Because the disclosed weld head 10 both shields the welding area and seals the area from gases leaking in, the need for wire brushing is substantially reduced or eliminated.

Spring pad/tubing seal 132 satisfies the need for clamping members to support metal tubing 32 while allowing for variances in nominal tube sizes. The springing and sealing force of spring pad/tubing seal 132 allows leakage of oxygen and/or atmosphere into the welding area during orbital welding. Spring pad/tubing seal 132 provides a flexible, high temperature seal to prevent air from being drawn in through the spring pad cuts and around irregular sized/shaped parts. Spring pad/tubing seal 132 also provides a set of sealing strips to seal and prevent gaseous flow through the collet seam 114. Interlocking clamping jaws 28 prevent air from being drawn in through the various seams. This combination prevents air from being drawn into the welding area for eliminating weld color, as well as for reducing component wear from oxygenation during the high temperature welding process.

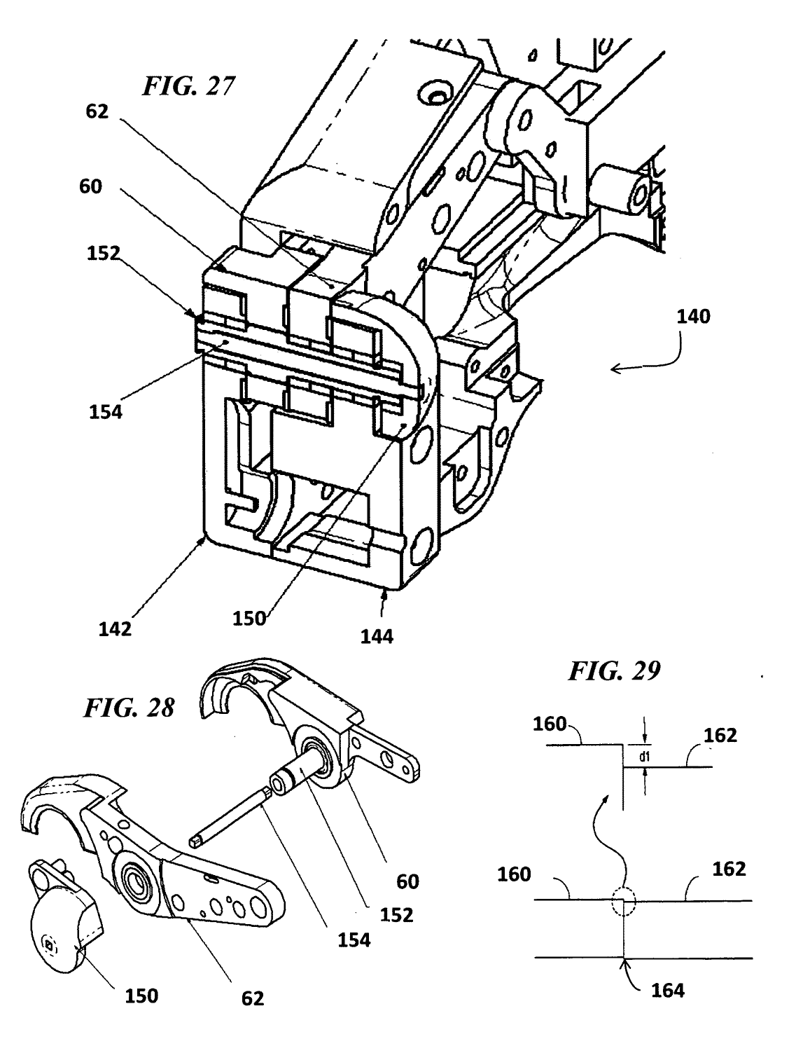

FIGS. 27 and 28 illustrate an embodiment of a torsion assembly 140 within interlocking clamping jaws 28 of the disclosed embodiment. Torsion assembly 140 includes right bottom jaw portion 142 and left bottom jaw portion 144, which for constituent parts of bottom jaw 42. Right top jaw portion 60 and left top jaw portion 62 form constituent parts of top jaw 40. Torsion cap 150 attaches to left top jaw portion 62. Torsion pin 152 attaches to right top jaw portion 60 and receives torsion rod 154. Torsion rod 154 passes through left top jaw port 62 to engage torsion cap 150.

Right top jaw portion 60 may clamp metal tubing 30 independently of left top jaw portion 62 while still being driven by the same mechanism with the use of a torsion rod 154. Right bottom jaw portion 142 and left bottom jaw portion 144 support torsion pin 152 while allowing it rotate freely. Right top jaw portion 60 attaches to torsion pin 152 while left top jaw portion 62 may rotate freely on torsion pin 152. Torsion cap 150 attaches to left top jaw portion 62 to rotate freely on the torsion pin 152. Torsion rod 154 attaches to torsion pin 152 at one end and to torsion cap 150 at the opposite end. Advancing left top jaw portion 62 causes rotation of torsion rod 154 by means of torsion cap 150. Rotating torsion rod 154 transfers motion to torsion pin 152, which further moves right top jaw portion 60. Right top jaw portion 146, therefore, advances relative to left top jaw portion 62 to make contact with a first piece of metal tubing 31. Continuing motion of left top jaw portion 62 twists the torsion rod 154. Twisting of torsion rod 154 forms a spring to apply pressure to right top jaw portion 60 and thus cause clamping of a second piece of metal tubing 31.

FIG. 29 through 31 illustrate aspects of the disclosed orbital welding system 14 for determining and misalignment between two metal tubing 30 segments as part of an orbital welding process. Referring to FIG. 29, metal tubing first section 160 and second section 162 are substantially the same diameter and are substantially contiguous when interlocking clamping jaws 28 are fully closed in preparation for welding at joint 164. The distance by which the weldable first section 160 and second section 162 deviate from perfect alignment is shown as “d1” in FIG. 29 and is measured at the largest exposed edge of first section 160 at junction 164 with second section 162.

FIG. 30 illustrates an embodiment of torsion assembly 170 presently disclosed orbital welding system 14 for measuring the alignment, d1, between a first section 160 and a second section 162 of metal tubing 31. Certain elements of FIG. 30 have been previously introduced here at FIG. 13 in association with the description of interlocking clamping jaws 28. Referring now, however, to FIG. 30, right top jaw arm 172 rotatably engages link 48. Link 48 slidably engages rack 52 and left top jaw arm 46. Pinion 50 passes through left top jaw arm 46 to encoder 44.

Referring to both FIGS. 13 and 30, operation of interlocking clamping jaws 28 allows weld head 10 to sense the relationship between the top jaw 40 and bottom jaw 42. Any deviation between the location of the clamping surfaces of top jaw 40 and bottom jaw 42 causes link 48 to swing. The swinging of link 48 rotates rack 52. When rack 52 rotates, pinion 50 rotates. The rotation of pinion 50 rotates the wheel configuration of encoder 44. Rotation of encoder 44 sends an electrical signal via wires (not shown) to weld head interface box 18.

The configuration of link 48, rack 52, and pinion 50 provides a mechanical multiplier function. For every 0.001 inches of misalignment sensed through this arrangement, encoder sends 11 of distance to the programmable logic controller 242 of weld head interface box 18. Thus, even the slightest alignment variance results in a readable and controllable measurement. The resulting measurement allows an operator to take appropriate action to correct a misalignment condition before making the orbital weld.

FIG. 31 shows the operator display 34 on weld head 10 for indicating, among other information, a number corresponding to a measurement of distance, d1, between a first section 160 and a second section 162 of metal tubing 31. The distance measurement, d1, may be then expressed as an alignment value within a range of values.

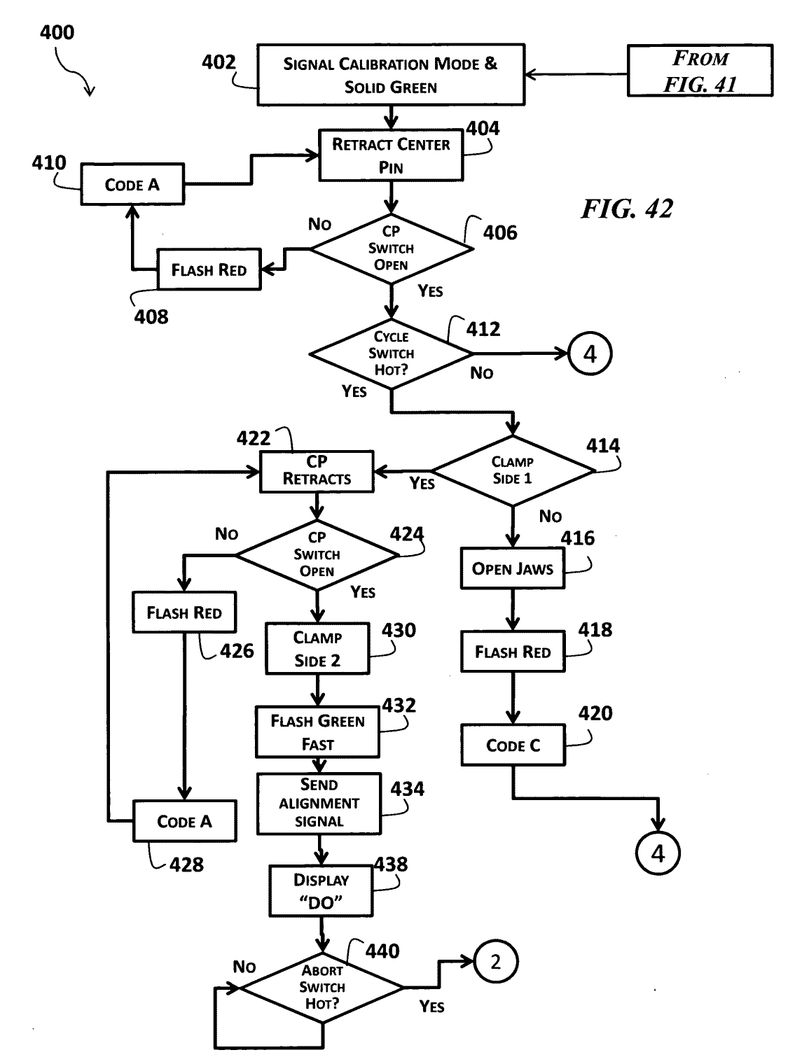

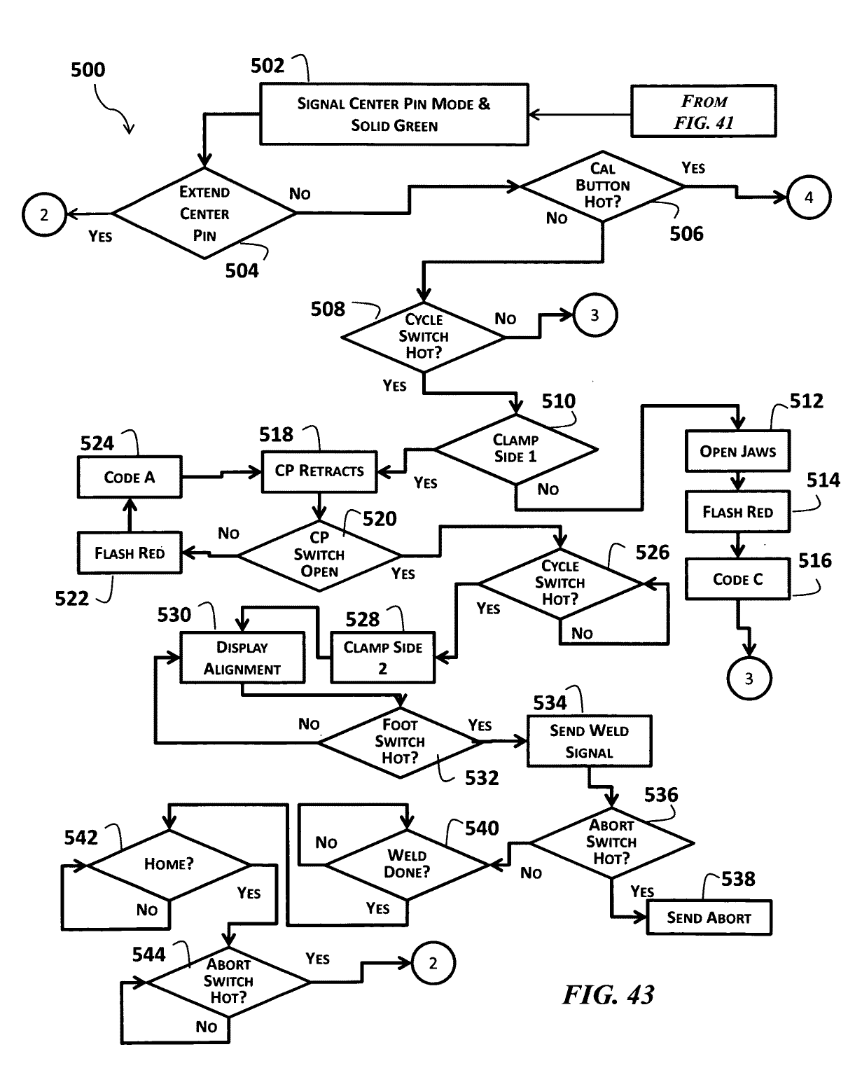

FIGS. 32 through 35 present various cut-away and exploded views of an embodiment of weld head 10 for the presently disclosed orbital welding system 14. FIG. 32 begins with an exploded view of component assemblies within casing 180 for weld head 10 and illustrates the relationship between the orbital weld head subassemblies. Subassemblies appearing in FIG. 32 include weld head clamping piston system 182, torsion assembly 170, spring collets 54, collet seal 130, encoder 44, bottom jaw 42, and gear drive motor and center piston assembly 184. At the end of casing 180 is quick disconnect assembly 186, which is described in more detail below in associations with FIGS. 42 and 43.

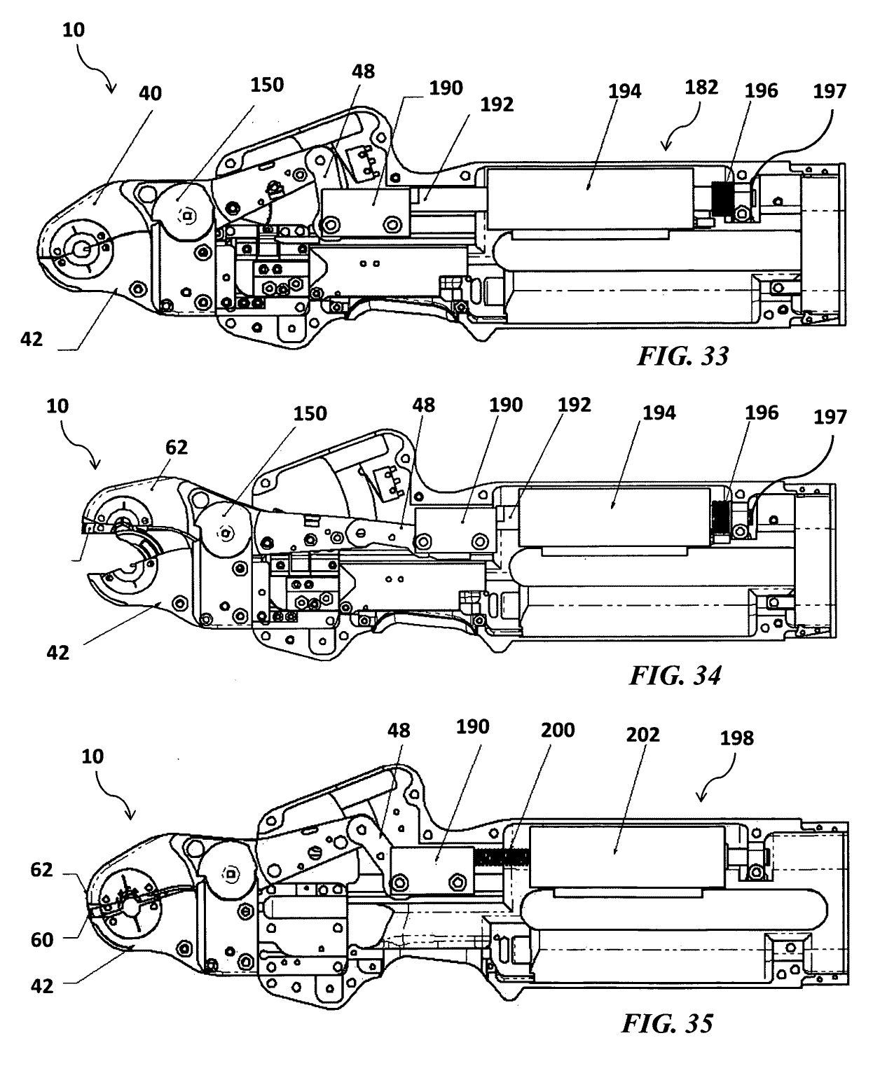

FIGS. 33 and 34 provide, respective, views of weld head 10 in a clamping position and an open position. Referring to both FIGS. 33 and 34, bottom jaw 42 provides a fixed support for holding collets 54. Top jaw 40 clamps side one of metal tubing 30, torsion cap 150 connects to top jaw 40. Top jaw 40 clamps second section 162 of metal tubing 30 to bottom jaw 42. Torsion cap 150 connects left top jaw portion 62 to right top jaw portion 60 and allows for adjustable clamping pressure by preloading torsion rod 154 (now shown). Link 48 (not shown) connects right top jaw portion 60 to clevis 190. Clevis 190 connects link 48 to piston assembly 182. Piston rod position 192 forms part of piston assembly 182. Piston assembly 182 provides a three-stage piston body 194 housing for piston rods. Piston rod position 196 includes a spring actuator as part of piston assembly 182.

In one embodiment weld head 10, as appears in FIG. 33 and 34, a use of stack of Bellville washers 197 may be positioned behind three-stage piston body 196 to prevent over-pressurizing the weld head 10. The Bellville washers 197 protect the weld head from twisting during clamping, i.e., the Bellville washers absorb torque by compression.

Weld head 10, as shown in FIGS. 33 and 34, provides adjustable spring pressure on right top jaw portion 60 and adjustable cushion spring for left top jaw portion 62. The disclosed embodiment provides that ability to tune the clamping pressure between the two metal tubing section 160 and 162 being clamped and provides a necessary degree of adjustability. This feature enables the operator to increase or decrease the clamping pressures between right top jaw portion 60 and left top jaw portion 62. Torsion cap 150 interlocks to torsion rod 154 and is radial connected to left top jaw portion 62. Torsion cap 150 may be adjusted by turning a setscrew found on the top of left top jaw portion 63. The embodiment of FIGS. 33 and 34 includes interlocking tabs to reduce further twisting.

Piston assembly 182 provides a three-stage piston with different clamping stages. The stages include the positions for clamping first section 160 of metal tubing 30, clamping second section 162 of metal tubing 30, and retracting the welded metal tubing 31. Two chambers inside housing 194 separately actuate independent piston rods. The positions can be operated independently. Weld head 10 supplies compressed air to piston housing 194, which drives piston rod 192 and clevis 190 forward. Clevis 190 rides on bearing in tract and drives the link 48 upward. The upward motion of link 48 swings left top jaw portion 62 towards the clamping surface of metal tubing 31. Left top jaw portion 62 connects to right top jaw portion 60 via torsion cap 150, in response to which right top jaw portion 60 clamps down.

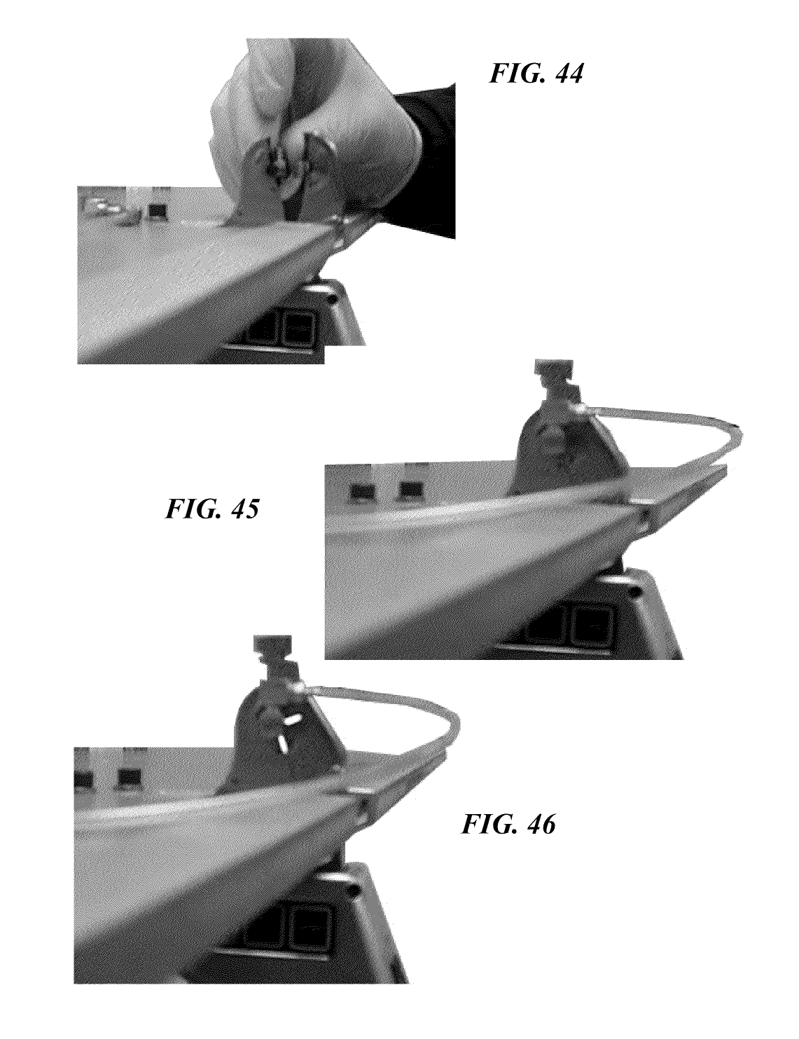

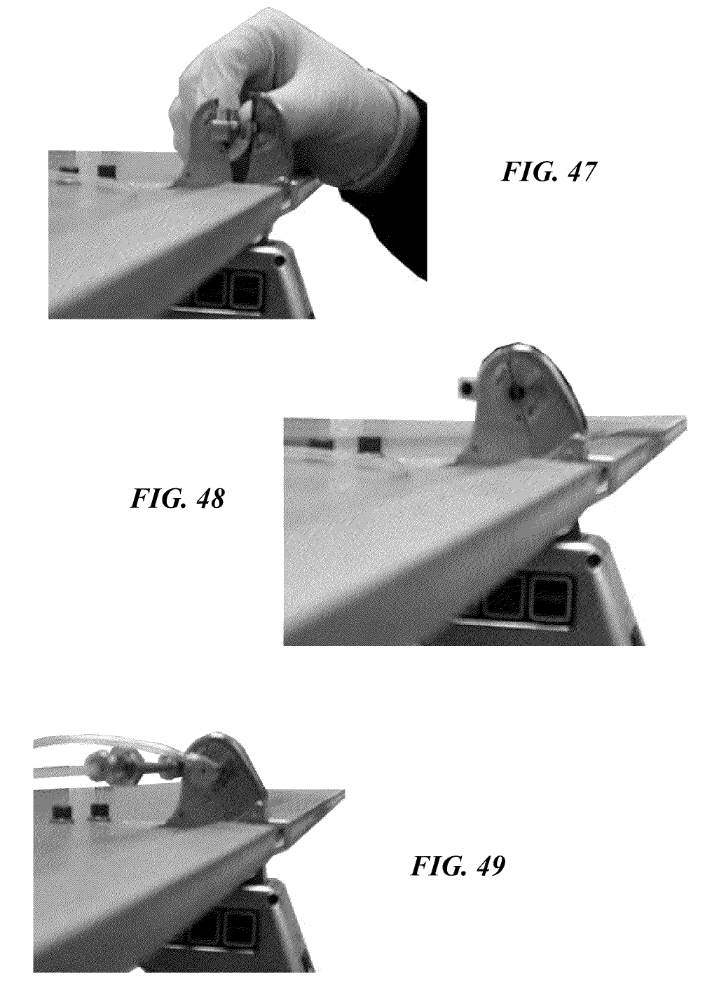

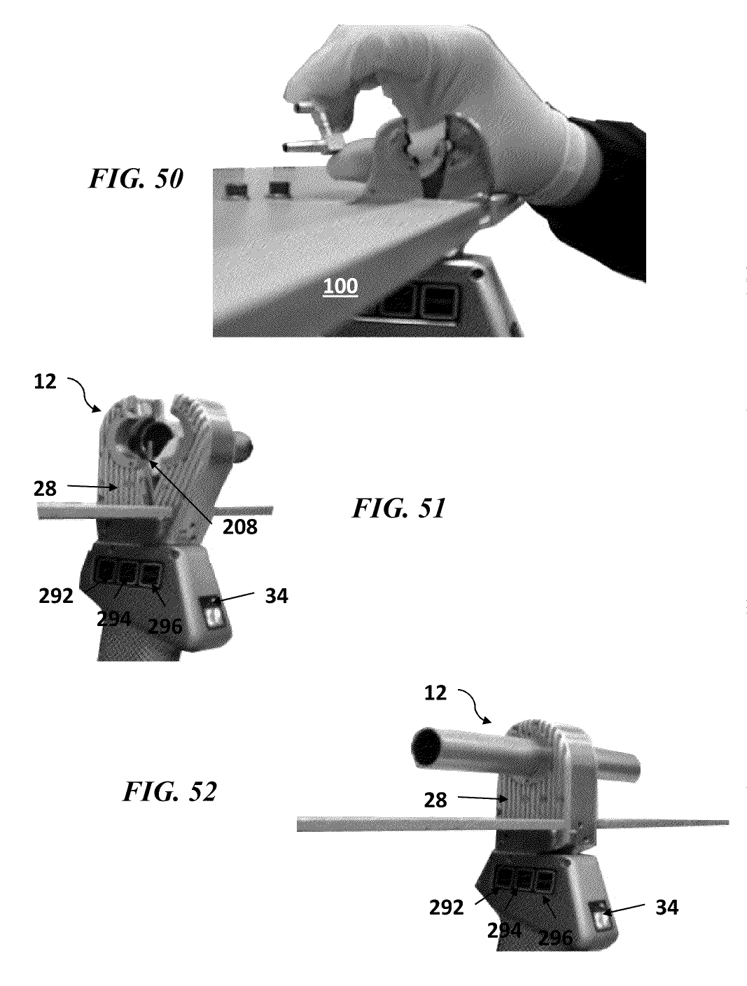

In operation, which will be shown also in FIGS. 44 through 54, first section 160 of metal tubing inserts into weld head 10. Second section 162 of metal tubing butts up against first section 160. Piston assembly 182 actuates to extend piston rod 192, thereby causing right top jaw portion 60 to clamp. Then, actuation of piston 196 causes left top jaw 62 to clamp second section 162 of metal tubing 31.

FIG. 35 illustrates an embodiment of the weld head 10 wherein the clamping force for interlocking clamping jaws 28 derives from a motor assembly 198. In FIG. 35, bottom jaw 40 is fixed to support and hold clamping collets. Right top jaw portion 60 clamps first section 160 of metal tubing 30, and torsion cap 150 connects to left top jaw portion 62. Left top jaw portion 62 clamps second section 162 of metal tubing 31. Link 48 connects left top jaw portion 62 to clevis 190. Clevis 190 connects link 48 to motor screw 200.

Motor screw 200 advances clevis 190. Motor 202 connects to motor screw 200. As motor screw 200 turns, the clevis 190 moves along the screw shaft. This moves the top jaw 42 towards the clamping position, as described above. Clevis 190 rides on bearing in tract and drives the link 48. This enables left top jaw portion 62 to advance toward clamping surface of metal tubing 31. Operation of interlocking clamping jaws 28 otherwise may be similar or identical to the operation previously described.

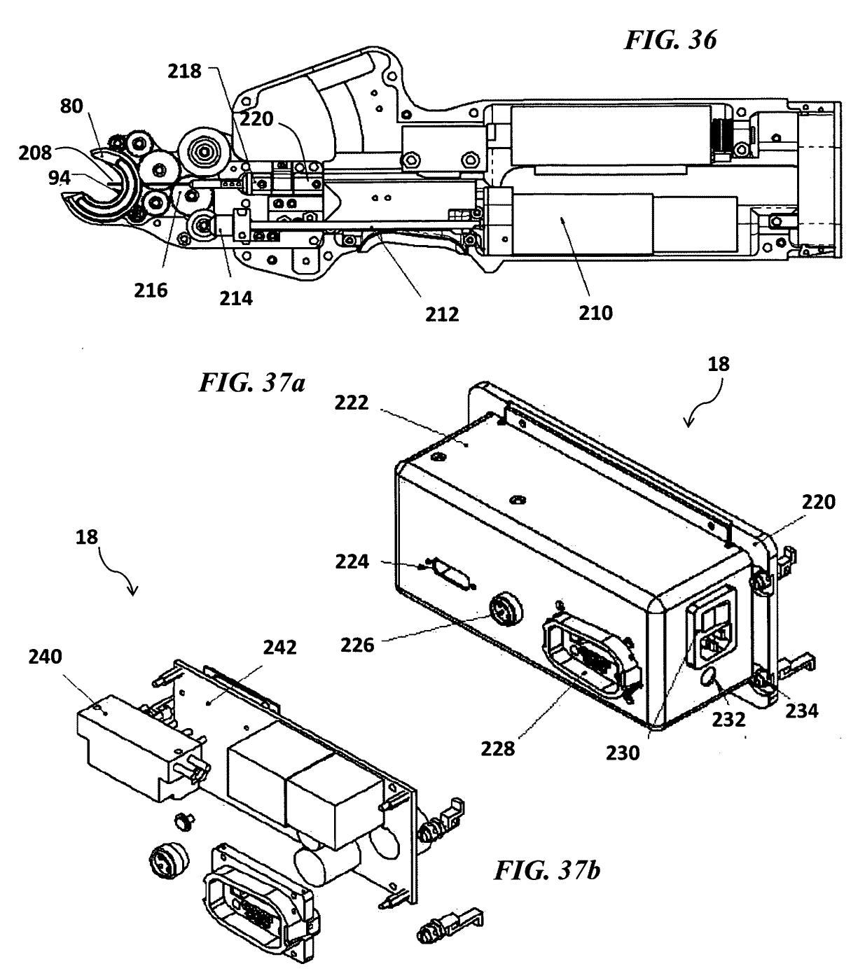

FIG. 36 presents an embodiment of the orbital weld head 10 gear drive and center pin 208. In FIG. 36, motor 210 moves drive shaft 212 to move miter gears 214. In response to motion of miter gears 214, gear drive 216 rotates welding electrode 94. Interlocking race 80 includes the weld gear/insulator/electrical strip, as described above in FIGS. 19 through 24. Centering piston 218 may move in response to air actuated, electrical solenoid operation, or other translational force. Motor 210 turns miter gears 214, which turn six-piece gear dive assembly 216. Gear drive assembly 216 turns interlocking race 80.

Interlocking race 80 is a multifunctional component including weld gear 84 and ceramic insulator 86 for insulating electrical current from ground. Ceramic insulator 86 contains electrical strip 88 that houses the welding electrode 94. Interlocking race 80 provides a three-piece assembly that allows electrical current to travel to electrode 94, while electrode 94 rotates.

Centering piston 218 provides a dual acting pneumatic cylinder 220. Cylinder component 220 operates at pressure to extend centering pin 208 and provide a stop for the centerline of electrode 94. Centering pin 208 provides a stop for clamping metal tubing 30 in line with electrode 94. After first section 160 of metal tubing 30 clamps in place, centering piston 218 moves to retract centering pin 208, thereby allowing second section 162 of metal tubing 30 to butt against first section 160 of metal tubing 31.

A distinction of weld head 10 of the present disclosure is that all gears may be formed of a highly durable stainless steel material. That is, the entire mechanical construction of weld head 10 differs from know constructions. A major contributing factor to the stainless steel, highly durable construction of weld head 10 derives from the way in which electricity passes through weld head 10 and into the welding environment of interlocking clamping jaws 28. This design reduces or substantially eliminates arcing that frequently occurs in known weld head designs for orbital welding. The result becomes the safer and much more rugged design of weld head 10.

FIGS. 37a and 37b show, respectively, outer and inner views of weld head interface box 18 for use between a welding system power supply and the presently disclosed orbital welding system. Weld head interface box 18 allows for the adaptation of an orbital welding system 14 to various power supplies. Orbital welding system 14 is automated by a programmable logic controller, which handles the inputs and outputs necessary for automation. The presently disclosed subject matter includes a technical process for sequencing all necessary functions of the orbital welding process. Control functions of orbital welding system 14 provide automated clamping, centering pin function, alignment verification, auto-cooling, and various alarm features. FIGS. 39 through 42, below, describe in detail the steps of the presently disclosed orbital welding process.

Weld head interface box 18 includes mounting bezel 220 for enclosure 222. Weld head interface box 18 further provides a connector 224 for remote pendant for welder and connector 226 for foot pedal interface. A weld head quick disconnect interface 228 allows easy connection to weld head interface cable 16. A 120 VAC power inlet interface 230 and compressed air inlet connection 232 appear on a side of enclosure 222. A set of ¼ turn latches 234 enable attaching weld head interface box 18 to a welding system power supply system 22 (see FIG. 4).

FIG. 37b shows weld head interface box 18 with enclosure 222 removed. Within weld head interface box appear air solenoid bank 240 and programmable logic controller 242.

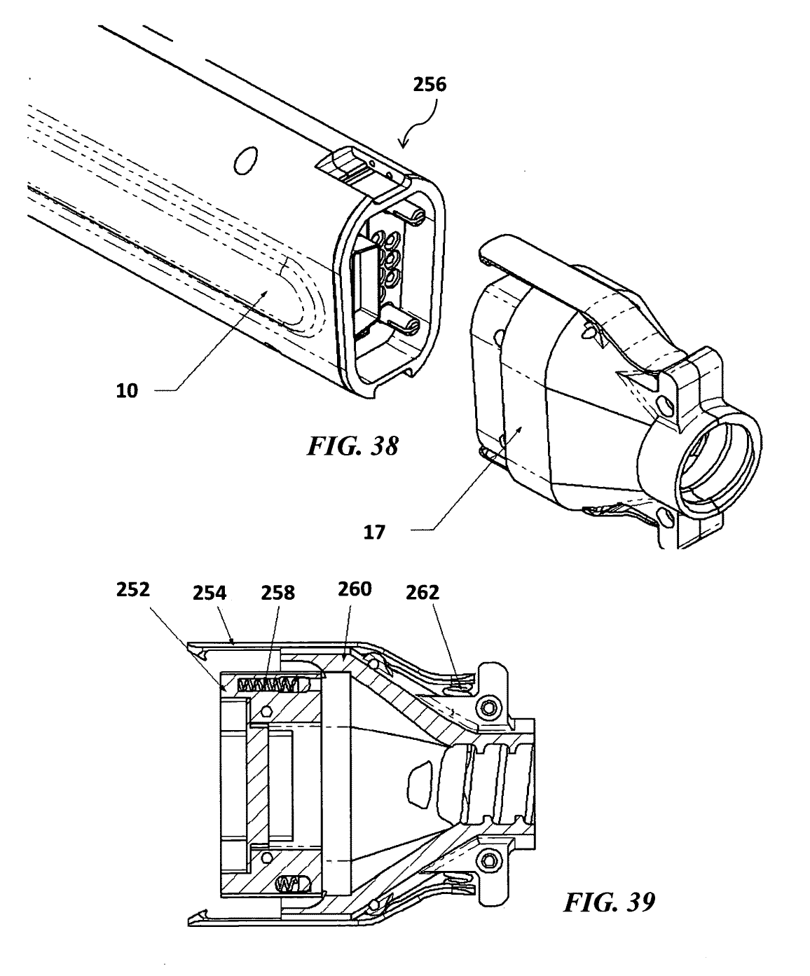

FIGS. 38 and 39 show isometric views of a quick disconnect cable connection for an embodiment of the presently disclosed orbital welding system 14. Referring to FIGS. 38 and 39, a quick disconnect cable connection 17 to orbital weld 10. Quick disconnect connection 17 interface housing 252 provides electrical and air connections that feed into weld head interface cable 16. Latch 254 secures quick disconnect connection 17 onto interfacing latch recesses 256 of weld head 10. Spring 258 operates within interface housing 252. Outer housing 260 provides structural strength for quick disconnect connection 17 and includes latch spring 262.

Interface housing 252 is guided within the outer housing 260 and is spring loaded with spring 258. When the connection is made to weld head 10 the o-ring seals on the weld head are compressed enough to seal the air and head purge. All of the necessary electrical connections are made simultaneously when latches 254 interlock onto weld head 10.

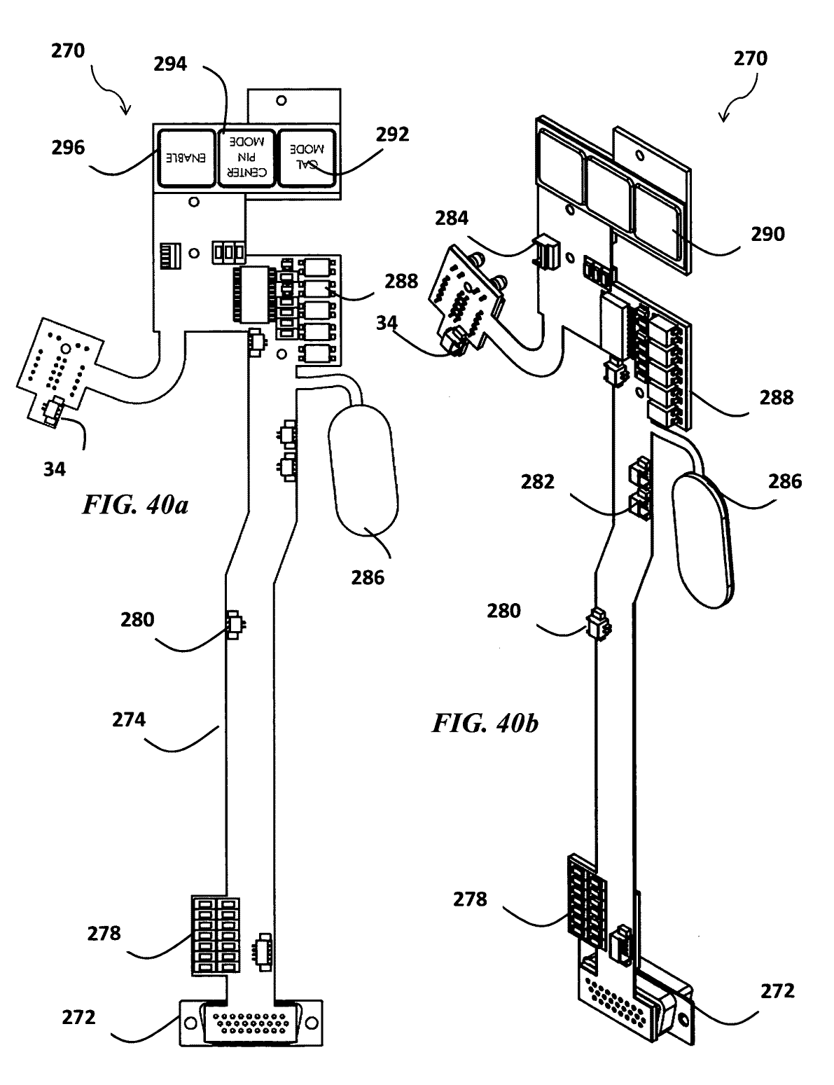

FIGS. 40a and 40b present views of an electronic flex circuit 270 for providing electrical and informational signals to control circuitry for operating weld head 10. Flex circuit 270 includes serial connector 272 which is positioned within interfacing latch recesses 256 of weld head 10. Flexible conductive path 274 connects a variety of electrical and electronic components to serial connector 272. The electrical components associated with conductive path 274 include a set of capacitors and other filtering circuit components 276, 278, 280, 282, and 284, which serve to control and manage the high frequency noise associated with welding. Further connections through conductive path 274 include control switch 286, which permits an operator to control weld head 10 during operations. Operator panel 34 provides an LED readout of weld head 10 status and other operational parameters associated with orbital welding system 14. Control microprocessor 288 interfaces through conductive path 274 and serial connector 272 to programmable logic controller 242 within weld head interface box 18. LED indicators 290 show the weld head 10 status and include an “ENABLE” indicator 292, a “CENTER PIN MODE” indicator 294, and a “CAL MODE” indicators 296.

Flex circuit 270 is designed to avoids high frequency noise associated with orbital welding in weld head 10, while also allowing weld head 10 to be of a sleek, efficient design. High frequency noise within weld head 10 causes a wide range of problems, including unintentionally resetting control microprocessor 288 and causing equipment malfunction piston assembly 282 and other electrical components within weld head 10. The various filter capacitors and other circuitry associated within flex circuit 270 filter the electrical and electrostatic noise associated with orbital welding. Thus, while it is not practical to eliminate such electrical and electrostatic noise, through the appropriate selection of filtering capacitors, flex circuit 270 provides the ability manage and direct such noise to ground or other circuitry for dissipation. This results in a more reliably and predictably operating orbital welding system 14.

FIGS. 41 through 43 illustrate an embodiment of control process operating within an embodiment of the presently disclosed orbital welding system. In the following description of the control process for orbital welding system 14, events result in differing indications that notify the operator of weld head 10 status.

Circled numerals 2, 3, and 4 in the process flow diagrams of FIGS. 41 through 43 relate to the following indications on operator panel 34:
(2)→FAST FLASH [0.1 second]
(3)→SLOW FLASH [0.5 second]
(4)=Left decimal point on operator panel 34 lights solid whenever home switch is depressed.
   In similar manner, several alarm codes appear in the process flow diagrams of FIGS. 41 through 43 as follows:

| | | |
|---|---|---|
| CODE A | → | Center Pin alarm |
| CODE B | → | Home position alarm |
| CODE C | → | Safety switch alarm |

There may be other indications appropriate to differing embodiments of the disclosed orbital welding system 14.

Referring now to FIG. 41, process flow 300 depicts steps directed by programmable logic controller 242 of weld head interface box 18. At start step 302, process flow goes to power up step 304. Initially after power up step 304, a stop weld step 306 occurs to permit query 308 to discern that an enable condition exists. If not, process control stays at query 308 until an enable condition exists.

If an enable condition exists, then query 308 directs process flow to query 310 to discern whether weld head 10 is the home position. If not, query 310 directs process flow to step 312, causing operator panel 34 flash red, then to step 314, causing a code B condition exist, thereby indicating that weld head 10 is not in the home position. If, however, weld head 10 is in the home position, then query 310 directs process flow to query 316 for discerning that the CAL (calibration) button is hot. If yes, then process flow shifts to the calibration process flow 500 of FIG. 42. If no, then query 316 directs process flow to query 318 for discerning that the CP (center pin) mode button is hot. If yes, query 318 directs process flow to the center pin process flow 400 of FIG. 43. If not, query 318 directs process flow step 320 at which weld head 10 signals basic mode operation and operator panel 34 indicates solid green.

In the basic mode indicated at step 320, process flow continues to step 322 for retracting center pin 208 and then discerning at query 324 whether the center pin switch is open. If no, process flow continues to step 326 for operator panel 34 to flash red and step 328 to issue a code A or center pin alarm indication. If query 324 discerns the center pin switch to be open, then process flow continues to query 330 for testing whether the cycle switch is hot. If not, process flow continues to operator panel 34 indication 2, which is a fast flash of 0.1 second duration. If yes, process flow continues to query 332, to discern the presence of a clamp side 1 condition. If query 332 discerns a clamp side 1 condition not to exist, then process flow continues to step 334, at which weld head 10 opens interlocking clamping jaws 28. Then, at step 338 an operator panel 34 code c condition occurs for indicating a safety switch alarm condition and a fast flashing of operator panel 34 occurs.

If at query 332, a clamp side 1 condition exists, then process flow continues to query 348 for discerning a cycle switch hot condition exists. If not, process flow cycles at query 348 until a cycle switch hot condition exists. If yes, then process flow continues to step 342 for clamping side 2. Then, at step 344, operator panel 34 displays alignment and process flow proceeds to query 346. Query 346 discerns a cycle switch hot condition. If yes, process flow goes to step 348 to send for sending a weld signal to weld head 10. If not, process flow returns to step 344 to display alignment until a weld signal exists.

At step 348, process flow 300 causes programmable logic controller 242 to sends a weld signal to weld head 10. Thereafter, process flow 300 continues to discern, at query 350 whether an abort switch hot condition exists. If not, query 350 continues to test for such condition. If so, step 352 sends an abort signal to weld head 10 to abort the welding operation.

At abort in the presently disclosed orbital welding system, weld head 10 stops welding. Then, weld head 10 pauses for 0.5 second, opens interlocking clamping jaws 28, and resets all control logic.

FIG. 42 shows the process flow 400 in the calibration mode, as discerned at 316 of FIG. 41. In process flow 400, operator panel 34 signals that weld head 10 is in the calibration mode at step 402. Then, process flow 400 continues to step 404 for retraction of center pin 208. Query 406 discerns whether the center pin switch is open. If not, process flow goes to step 408, at which operator panel 34 flashes red and a code A CP alarm issues from weld head 10. If so, then process flow continues to query 412 for discerning whether the cycle switch is hot. If not, the left decimal point on operator panel 34 lights solid whenever home switch is depressed. If yes, process flow proceeds to query 414 for discerning that a clamp side 1 condition exists.

If a clamp side 1 condition does not exist, as tested at query 414, then process flow goes to step 416 for opening interlocking clamping jaws 28. Then, at step 418, operator panel 34 flashes red, and a code C alarm issues to show a safety switch alarm condition.

If a clamp side 1 condition exists, as tested at query 414, the process flow continues to step 422 for retracting center pin 208. Query 424 discerns whether the center pin switch is open. If not, then process flow goes to step 426 for operator panel 34 to flash red, and then to step 428 for a code A alarm to issue indication a center pin alarm condition.

If query 424 discerns the center pin switch to be open, then process flow continues to step 430, wherein weld head 10 clamps side 2. At step 432, operator panel 34 flashes a fast green indication and, at step 434, an alignment signal issues. Step 438 displays a “DO” indication on operator panel 34. Thereafter, query 440 discerns whether the abort switch is hot. If so, then process flow causes operator panel 34 to flash fast at 0.1 second duration. Otherwise, query 440 continues to test for the abort switch hot.

FIG. 43 depicts process flow 500 associating with orbital welding system 14 operating weld head 10 in the center pin mode, as discerned at query 318 of FIG. 41. Process flow 500 begins at step 502 wherein operator panel 34 signals the center pin mode and displays a sold green. Then, process flow 500 proceeds to query 504 for discerning whether center pin 208 is extended. If so, then operator panel 34 flashes fast. Otherwise, process flow continues to query 506 for discerning whether the calibration button is hot. If yes, then process flow causes the left decimal point on operator panel 34 to light solid whenever home switch is depressed. If not, process flow goes to query 508 for discerning whether the cycle switch is hot. If not, then process flow causes operator panel 34 to flash slowly. If yes, then process flow goes to query 510.

Query 510 discerns whether a clamp side 1 condition exists. If not, at step 512, interlocking clamping jaws 28 open. Then, at step 514, operator panel 34 flashes red and, at step 516, a code C condition exists to issue a safety switch alarm indication. If a clamp side 1 condition exists, then process flow continues to step 518 at which center pin 208 retracts. Then, query 520 discerns whether a center pin switch open condition exists. If not, at step 522, operator panel 34 flashes red and, at step 524, a code A condition exits to issue a center pin alarm indication.

If a center pin switch open condition exists, as query 520 tests, then process flow continues to query 526. Query 526 discerns a cycle switch hot condition. If no condition cycle switch hot condition exists, then query 526 continues to test for such condition. Otherwise, a cycle switch hot condition exists and process flow goes to step 528 for clamping side 2. Then, at step 530, operator panel 34 displays alignment.

Query 532 discerns whether the foot switch is hot. If not, then process flow cycles through to step 530, at which operator panel displays alignment. Once a foot switch hot condition exists, process flow goes to step 534 for programmable logic controller 242 to send a weld signal to weld head 10.

Query 536 discern whether an abort switch hot condition exists. If so, at step 538 programmable logic controller 242 sends an abort signal to weld head 10. Otherwise, process flow goes to query 540 for testing whether the weld is done. If not, then process flow cycles through query 540. Otherwise, process flow continues to query 542 to discern whether weld head 10 is in the home position. If not, process flow cycles through query 542. Otherwise, query 544 then tests whether the abort switch is not. If not, process flow cycles through query 544. Otherwise, weld head 10 goes to status 2 wherein operator panel 34 flashes fast at 0.1 second duration flashes.

FIGS. 44 through 50 depict use of an embodiment of the presently disclosed orbital welding system for welding smaller diameter metal tubing. To calibrate, the operator depresses the CAL button on the handle of weld head 10. When this process begins, the next step is to place the first section of metal tubing to be welding into the right portion interlocking clamping jaws. This may be visually set and then clamped in place. Then, the process includes placing the second piece to welded into the left portion of interlocking clamping jaws 28. Then, the second part is clamped in.

The foot pedal is then pressed. The panel indicator then shows the number “19” and then there will be a flashing green light. The “19” means that the calibration procedure is begun. After the centering pin slides, the operator depresses the CAL button again. This is the 0-0 position and the reference for all other welding. This sets a baseline for alignment accuracy.

Once this procedure is finished, the system is ready to weld. This provides to the operator a couple of options. There is the center pin option, which aligns the edge of the tube with the centerline of the electrode. When the operator selects the center pin option, a small pin extends into the welding area. The small pin aligns the quadrant of the pin with the centerline of the electrode.

The operator places the first section to be welded up against the centering pin. He then presses the feet pedal. The pin drops out automatically and the tubing is clamped in alignment with the electrode.

Then, the second tubing piece is inserted. The left side of interlocking clamping jaws 28 is slightly larger than the tubing to allow the insertion of the tubing to meet the first piece. That is, the second piece butts up against the first piece in preparation for the welding. Then, the foot peddle is depressed a second time. The alignment reading is then shown.

There is a value is determined to be in or out of range for the alignment. We typically are seeking a calibration within a predetermined tolerance.

When calibrating weld head 10, the operator places test pieces within the weld head. This passes to the pin, which proves that the tubing is not only in alignment, but also that it is straight. This pin is 1/1000^{th} of the inside diameter of the tubing. This provides information indicating that it is accurate going straight across from the first piece to the second piece.

Hitting the calibration button the second time zeroes it out. After the weld head is aligned, the operator is ready to weld. The operator then places the first piece in the weld head in against the center pin. Then the operator depresses the foot pedal to secure the first piece. [00112] Then, the second piece is inserted to butt again to push up against the first fitting. The weld system then shows the deviation from alignment on the indicator panel. For example, the indicator panel may show the number “3,” which is an acceptable deviation from zero that will provide and acceptable weld. For the presently disclosed system, the number “3” may relate to an alignment of 0.0015″

This shows an indicator of alignment, for example, on a scale of 1 to 10. The numbers may vary according to the size of tubing and the degree of alignment needed to perform a particular weld. Also, different ways of measuring the alignment may be used. Nonetheless, the indicator shows to the operator whether there exists the necessary alignment between the first piece and the second piece to make possible a satisfactory weld.

So, while the indicator is an accurate measurement of alignment, it is not necessarily to be converted to linear measurements such as millimeters or microns.

Once the two pieces are in place, the operator depresses the foot pedal a third time. With the two pieces in place, the third pedal action initiates the weld sequence.

The system also provides indication of low gas situations and other operating parameters.

FIGS. 51 and 52 further depict use of another embodiment of the presently disclosed orbital welding system for welding a larger diameter metal tubing. In this use, the operator places the two metal tubing sections as described above. Once the weld sequence is complete, the weld head opens automatically. This allows the operator to remove the tubing from the solid jaw that receives the tubing and holds the tubing in place. The centering pin is for centering the tubing in preparation for the welding.

As the tubing is placed, the numbers on the indicator indicate the alignment of the tubing while in the clamp. When a number exceeds a predetermined limit, the weld head should be opened to readjust the tubing. The indicator is the means for making sure that alignment supports the orbital welding process. Alignment may occur essentially instantaneously.

With every tube, there is a pressure differential that is needed to make sure (¼ tubing 4 lbs; 1″ tubing is 1.5 lbs.) contaminants do not enter the tubing.

There is a 10-second auto-cooling lockout. This provides auto-cooling function that. The 10-second cooling prevents an overheating condition with the weld head. This is variable, based on the diameter of the tube and how much heat is being generated.

Now, with the calculation, the operator steps on side one. Then on side two. He sees the CA on the indicator and the number “19,” the default number. The 19 means that the weld head is being calibrated or is completely out of range. Then, the operator depresses the CAL button for the calibration to occur and zeroes out the alignment.

Once the tubing pressure is at operational range. When the weld head is welding, the indicator has a light that dances around the screen perimeter.

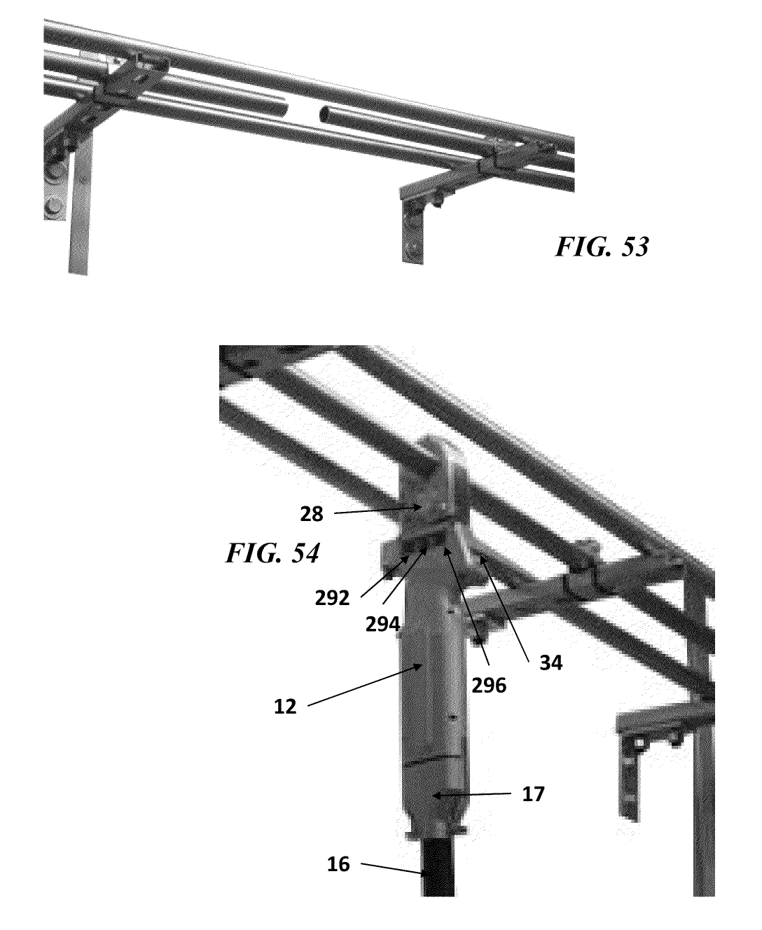

FIGS. 53 and 54 yet further depict use of the presently disclosed orbital welding system in a field situation for which a workbench weld process may be undesirable. In the field the operator may need to weld tubing that are in an overhead rack with other tubes. The operator will grab the weld head in the center pin mode. Then, the operator places the weld head on the tubing. The operator can simply clamp on the head without looking in the head. The operator butts the tube into the weld head.

Next the operator may insert the second piece in the weld head. Weld head 10 aligns and secures the tubes. On determining that an acceptable alignment exists, as determined by the reading on operator panel 34, the operator may initiate the orbital welding. There is not the need visually inspect for alignment prior to operating the weld head for welding. This prevents the need to guess and expect where the tube ends are.

All references, including publications, patent applications, and patents, cited herein are hereby incorporated by reference to the same extent as if each reference were individually and specifically indicated to be incorporated by reference and were set forth in its entirety herein.

The process flows of the disclosed subject matter may be described in the general context of computer-executable instructions, such as program modules, being executed by a computer. Generally, program modules include routines, programs, objects, components, data structures, etc. that performs particular tasks or implement particular abstract data types. The disclosed subject matter may also be practiced in distributed computing environments wherein tasks are performed by remote processing devices that are linked through a communications network. In a distributed computing environment, program modules may be located in local and/or remote computer storage media including memory storage devices.

The detailed description set forth below in connection with the appended drawings is intended as a description of exemplary embodiments in which the presently disclosed process can be practiced. The term “exemplary” used throughout this description means “serving as an example, instance, or illustration,” and should not necessarily be construed as preferred or advantageous over other embodiments. The detailed description includes specific details for providing a thorough understanding of the presently disclosed method and system. However, it will be apparent to those skilled in the art that the presently disclosed process may be practiced without these specific details. In some instances, well-known structures and devices are shown in block diagram form in order to avoid obscuring the concepts of the presently disclosed method and system.

Although the orbital welding system and methods of operation here disclosed have been described in detail herein with reference to the illustrative embodiments, it should be understood that the description is by way of example only and is not to be construed in a limiting sense. It is to be further understood, therefore, that numerous changes in the details of the embodiments of this disclosed process and additional embodiments of this anomaly detection process will be apparent to, and may be made by, persons of ordinary skill in the art having reference to this description. It is contemplated that all such changes and additional embodiments are within the spirit and true scope of this disclosed method and system as claimed below.

What is claimed is:

1. An orbital welding system for controllably and safely welding a first weldable tubular material to a second weldable tubular material, comprising:
a weld head for orbitally welding the first weldable tubular material to the second weldable tubular material, said weld head further comprising:
interlocking clamping jaws for sequentially clamping first the first weldable tubular material and then the second weldable tubular material;
alignment mechanism for aligning the second weldable tubular material with the first weldable tubular material following said interlocking clamping jaws first clamping said first weldable tubular material;
said interlocking clamping jaws comprising means for clamping the second weldable tubular material following the aligning of the second weldable tubular material with the first weldable tubular material;
alignment measurement mechanism for measuring relative alignment between the first weldable tubular material and the second weldable tubular material;
a weld environment mechanism for establishing a gaseous environment for orbitally welding the first weldable tubular material to the second weldable tubular material, said weld environment mechanism comprising a weld environment sealing mechanism for sealing said gaseous environment and an electrode for gas arc welding, said weld environment mechanism associated to orbit the first weldable tubular material and second weldable tubular material in orbitally welding the first weldable tubular material with the second weldable tubular material; and
weld head interface circuitry for interfacing a welding power supply with said weld head and programmably controlling operational and safety parameters associated with said weld head.

2. The orbital welding system of claim 1, further comprising weld head interface circuitry associated within a weld head interface box, said weld head interface box comprising a programmable logic controller and associated electrical and processing connections for interfacing said weld head with a plurality of industry standard welding power supplies.

3. The orbital welding system of claim 1, further comprising:
a center pin alignment mechanism associated with said interlocking clamping jaws and said weld environment mechanism for receiving sequentially the first weldable tubular material and the second weldable tubular material;
alignment encoder mechanism for encoding a physical relative alignment measurement into a digital signal; and
an operator display for displaying said digital signal as a numerical measurement of relative between the first weldable tubular material and the second weldable tubular material.

4. The orbital welding system of claim 1, further comprising within said interlocking clamping jaws an alignment mechanism for positioning said electrode with the weld area during the alignment of the first weldable tubular material with the second weldable tubular material.

5. The orbital welding system of claim 1, further comprising prevents weldable material pieces from separating during the welding process due to twisting or other stresses arising during welding.

6. The orbital welding system of claim 1, further comprising a three-stage piston assembly for sequentially operating first a first portion of said interlocking clamping jaws and second a second portion of said interlocking clamping jaws, said three-stage piston assembly for avoiding twisting of the weld area as said weld environment mechanism orbits said electrode rotates around the first weldable tubular material and the second weldable tubular material during orbital welding.

7. The orbital welding system of claim 1, further comprising weld head interface circuitry and associated instructions for controllably operating said weld head in at least one of a basic mode, a calibration mode, or a center pin mode.

8. The orbital welding system of claim 1, further comprising foot pedal control circuitry and mechanism for controlling said weld head using foot control.

9. The orbital welding system of claim 1, further comprising a quickly interchangeable spring collet configuration associated with said weld environment mechanism for quickly and easily exchanging different diameter collets and, thereby, orbitally welding weldable tubular materials having a variety of different diameters.

10. The orbital welding system of claim 1, further comprising within said weld environment mechanism an interlocking race and ceramic insulator for increasing cooling between sequential orbital welding operations.

11. The orbital welding system of claim 1, further comprising within said weld environment a tight weld gas environment for preventing reactions with oxygen and reactive gas during and after welding.

12. The orbital welding system of claim 1, further comprising a weld head cable for connecting between said weld head and said weld head interface circuitry and at least one quick disconnect mechanism for permitting a quick interchange between said weld head interface circuitry and a variety of differently configured weld heads.

13. A method for orbital welding a first weldable tubular material to a second weldable tubular material, comprising the steps of:
orbitally welding the first weldable tubular material to the second weldable tubular material using a weld head, said orbitally welding further comprising the steps of:
sequentially clamping first the first weldable tubular material and then the second weldable tubular material using interlocking clamping jaws associated with said weld head;
aligning the second weldable tubular material with the first weldable tubular material following said interlocking clamping jaws first clamping said first weldable tubular material using an alignment mechanism associated with said weld head;
clamping the second weldable tubular material following the aligning of the second weldable tubular material with the first weldable tubular material using said interlocking clamping jaws;
measuring relative alignment between the first weldable tubular material and the second weldable tubular material using alignment measurement mechanism associated with said weld head;
establishing a gaseous environment for orbitally welding the first weldable tubular material to the second weldable tubular material using a weld environment mechanism associated with said weld head and further performing the steps of:
sealing said gaseous environment using a weld environment sealing mechanism associated with said weld environment mechanism,
orbiting the first weldable tubular material and second weldable tubular material using said weld environment mechanism, and
welding the first weldable tubular material with the second weldable tubular material using a gas arc welding electrode; and
interfacing a welding power supply with said weld head and programmably controlling operational and safety parameters associated with said weld head using weld head interface circuitry.

14. The orbital welding method of claim 13, further comprising the steps of associating with said weld head a weld head interface box comprising a programmable logic controller and associated electrical and processing connections for interfacing said weld head with a plurality of industry standard welding power supplies.

15. The orbital welding method of claim 13, further comprising the steps of:
associating a center pin alignment mechanism with said interlocking clamping jaws and said weld environment mechanism;
receiving sequentially the first weldable tubular material and the second weldable tubular material;
encoding a physical relative alignment measurement into a digital signal alignment encoder mechanism; and
displaying said digital signal as a numerical measurement of relative between the first weldable tubular material and the second weldable tubular material an operator display.

16. The orbital welding method of claim 13, further comprising the step of controllably operating said weld head in at least one of a basic mode or a calibration mode, or a center pin mode using weld head interface circuitry and associated instructions.

17. The orbital welding method of claim 13, further comprising the step of sequentially operating a three-stage piston assembly for first clamping a first portion of said interlocking clamping jaws and second clamping a second portion of said interlocking clamping jaws, thereby avoiding twisting of the weld area as said weld environment mechanism orbits said electrode rotates around the first weldable tubular material and the second weldable tubular material during orbital welding.

18. The orbital welding method of claim 13, further comprising the step of controlling said weld head with foot control foot pedal control circuitry and a foot pedal mechanism.

19. A weld head for orbitally welding the first weldable tubular material to the second weldable tubular material, comprising:
interlocking clamping jaws for sequentially clamping first the first weldable tubular material and then the second weldable tubular material;
alignment mechanism for aligning the second weldable tubular material with the first weldable tubular material following said interlocking clamping jaws first clamping said first weldable tubular material;
said interlocking clamping jaws comprising means for clamping the second weldable tubular material following the aligning of the second weldable tubular material with the first weldable tubular material;
alignment measurement mechanism for measuring relative alignment between the first weldable tubular material and the second weldable tubular material;
a weld environment mechanism for establishing a gaseous environment for orbitally welding the first weldable tubular material to the second weldable tubular material, said weld environment mechanism comprising a weld environment sealing mechanism for sealing said gaseous environment and an electrode for gas arc welding, said weld environment mechanism associated to orbit the first weldable tubular material and second weldable tubular material in orbitally welding the first weldable tubular material with the second weldable tubular material; and
weld head circuitry for interfacing weld head interface circuitry, said weld head interface circuitry for interfacing a welding power supply with said weld head and programmably controlling operational and safety parameters associated with said weld head.

20. The weld head of claim 19, further comprising weld head interface circuitry associated within a weld head interface box, said weld head interface box comprising a programmable logic controller and associated electrical and processing connections for interfacing said weld head with a plurality of industry standard welding power supplies.

21. The weld head of claim 19, further comprising:
a center pin alignment mechanism associated with said interlocking clamping jaws and said weld environment mechanism for receiving sequentially the first weldable tubular material and the second weldable tubular material;
alignment encoder mechanism for encoding a physical relative alignment measurement into a digital signal; and
an operator display for displaying said digital signal as a numerical measurement of relative between the first weldable tubular material and the second weldable tubular material.

22. The weld head of claim 19, further comprising weld head circuitry and associated instructions for controllably operating said weld head in at least one of a basic mode or a calibration mode, or a center pin mode.

23. The weld head of claim 19, further comprising a three-stage piston assembly for sequentially operating first a first portion of said interlocking clamping jaws and second a second portion of said interlocking clamping jaws, thereby avoiding twisting of the weld area as said weld environment mechanism orbits said electrode rotates around the first weldable tubular material and the second weldable tubular material during orbital welding.

24. The weld head of claim 19, further comprising within said interlocking clamping jaws an alignment mechanism for positioning said electrode with the weld area during the alignment of the first weldable tubular material with the second weldable tubular material.

25. The weld head of claim 19, further comprising weld head interface circuitry and associated instructions for controllably operating said weld head in at least one of a basic mode or a calibration mode, or a center pin mode.

26. The weld head of claim 19, further comprising foot pedal control circuitry and mechanism for controlling said weld head using foot control.

27. The weld head of claim 19, further comprising a quickly interchangeable spring collet configuration associated with said weld environment mechanism for quickly and easily exchanging different diameter collets and, thereby, orbitally welding weldable tubular materials having a variety of different diameters.
